(19) United States
(12) Patent Application Publication
(10) Pub. No.: US 2016/0370946 A1
(43) Pub. Date: Dec. 22, 2016

(54) SIGNAL PROCESSING SYSTEM, TOUCH PANEL SYSTEM, AND ELECTRONIC DEVICE

(71) Applicant: SHARP KABUSHIKI KAISHA, Osaka (JP)

(72) Inventors: Seiichi HAMA, Osaka (JP); Mutsumi HAMAGUCHI, Osaka (JP)

(21) Appl. No.: 15/109,149

(22) PCT Filed: Mar. 11, 2015
(86) PCT No.: PCT/JP2015/057207

§ 371 Date: Jun. 30, 2016

(30) Foreign Application Priority Data
Mar. 12, 2014 (JP) 2014-049385

(51) Int. Cl. G06F 3/041; G06F 3/044

(52) U.S. Cl. CPC G06F 3/0418; G06F 3/044; G06F 2203/04111

(57) ABSTRACT

Noise mixing into a plurality of time-series signals time-discretely sampled based on a linear element is reduced. A sub-system (5a) performs frame-by-frame driving in which first frame driving to (M+1)-th frame driving are performed, in each of which first vector driving to (N+1)-th vector driving are performed. A sub-system (5b) performs a plurality-of-vector continuous driving in which k-th vector driving to (k+j)-th vector driving of each frame driving are performed.

### TECHNICAL FIELD

The present invention relates to a signal processing system that estimates a value of a linear element or an input of the linear element by performing addition-subtraction-based signal processing on a plurality of time-series signals time-discretely sampled based on the linear element, a touch panel system including a touch panel that includes a plurality of capacitors disposed at respective intersection points of a plurality of drive lines and a plurality of sense lines and a touch panel controller that controls the touch panel, and an electronic device.

### BACKGROUND ART

The inventors have proposed a touch panel controller that controls a touch panel including a plurality of capacitors disposed at respective intersection points of a plurality of drive lines and a plurality of sense lines and estimates or detects capacitances accumulated in the respective capacitors arranged in a matrix form (PTL 1).

This touch panel controller performs parallel driving on the plurality of drive lines on the basis of a code sequence to time-discretely sample and read along the respective sense lines linear-sum signals based on electric charge accumulated in the capacitors and estimates or detects capacitances of the capacitors by computing an inner product of the read linear-sum signals and the code sequence.

### CITATION LIST

### Patent Literature

PTL 1: Japanese Patent “No. 5231605 (registered on Mar. 29, 2013)”

### SUMMARY OF INVENTION

### Technical Problem

With the related art described above, however, noise mixes into the time-discretely sampled linear-sum signals, making estimation or detection of capacitances of the capacitors inaccurate. This consequently makes it difficult for the touch panel controller to operate favorably.

It is an object of the present invention to reduce noise mixing into an estimated result of a value or input of a linear element by performing addition-subtraction-based signal processing on the basis of input/output transfer characteristics and a frequency and an amount of noise mixing into a plurality of time-series signals time-discretely sampled based on the linear element.

### Solution to Problem

To this end, a signal processing system according to an aspect of the present invention is a signal processing system that estimates a value of a linear element or an input of the linear element by performing addition-subtraction-based signal processing on a plurality of time-series signals time-discretely sampled based on the linear element. The signal processing system includes a first sub-system and a second sub-system having different input/output transfer characteristics, and a switch circuit that switches between the first sub-system and the second sub-system and connects one of the first sub-system and the second sub-system to the linear element, based on a frequency and an amount of noise mixing into the time-series signals and the input/output transfer characteristics so as to reduce noise mixing into an estimated result of the value or input of the linear element. The first sub-system performs frame-by-frame driving in which first frame driving to (M+1)-th frame driving are performed, in each of which first vector driving to (N+1)-th vector driving each including even-numbered phase driving and odd-numbered phase driving are performed in this order (where N and M are integers). The second sub-system performs plurality-of-vector continuous driving in which k-th vector driving to (k+j)-th vector driving (where k and j are integers that satisfy 1≦k≦N and 1≦j≦N−1, respectively) of each frame driving are performed in this order.

To this end, a touch panel system according to an aspect of the present invention is a touch panel system including a touch panel including a plurality of capacitors disposed at respective intersection points of a plurality of drive lines and a plurality of sense lines, and a touch panel controller that controls the touch panel. The touch panel controller includes a drive circuit that drives the capacitors along the drive lines, amplification circuits that read along the respective sense lines and amplify a plurality of linear-sum signals based on respective capacitors driven by the drive circuit, an analog-digital conversion circuit that performs analog-digital conversion on outputs of the amplification circuits, a decoding computation circuit that estimates capacitances of electric charge accumulated in the capacitors on the basis of the analog-digital-converted outputs of the amplification circuits, a first sub-system and a second sub-system having different input/output transfer characteristics, and a switch circuit that switches between the first sub-system and the second sub-system and connects one of the first sub-system and the second sub-system to the linear elements. The first sub-system performs frame-by-frame driving in which first frame driving to (M+1)-th frame driving are performed, in each of which first vector driving to (N+1)-th vector driving each including even-numbered phase driving and odd-numbered phase driving are performed in this order (where N and M are integers). The second sub-system performs plurality-of-vector continuous driving in which k-th vector driving to (k+j)-th vector driving (where k and j are integers that satisfy 1≦k≦N and 1≦j≦N−1, respectively) of each frame driving are performed in this order.

To this end, an electronic device according to an aspect of the present invention includes the touch panel system according to the present invention and a display device compatible with the touch panel system.

### Advantageous Effects of Invention

According to an aspect of the present invention, an advantageous effect is obtained which successfully reduces noise mixing into an estimated result of a value or input of a linear element by performing addition-subtraction-based signal processing on the basis of input/output transfer characteristics and a frequency and an amount of noise mixing into a plurality of time-series signals time-discretely sampled based on the linear element.

### BRIEF DESCRIPTION OF DRAWINGS

FIG. 1 is a block diagram illustrating a configuration of a signal processing system according to a first embodiment.

FIG. 2 is a graph illustrating an amount of noise of a time-series signal processed by the signal processing system and a frequency characteristic between a sampling frequency and an amount of amplitude change of the time-series signal.

FIG. 3 is a circuit diagram illustrating a configuration of a touch panel system according to the first embodiment.

FIG. 4 is a circuit diagram for describing a driving method performed by the touch panel system.

FIG. 5 is a diagram for describing mathematical expressions representing the driving method performed by the touch panel system.

FIG. 6 is a circuit diagram illustrating a situation in which noise is applied to the touch panel system.

FIG. 7 is a circuit diagram for describing a parallel driving method performed by the touch panel system.

FIG. 8 is a diagram for describing mathematical expressions representing the parallel driving method performed by the touch panel system.

FIG. 9 is a diagram for describing mathematical expressions representing the parallel driving method performed by the touch panel system using an M-sequence code.

FIG. 10 is a circuit diagram illustrating a configuration of another touch panel system according to the first embodiment.

FIG. 11 Parts (a), (b), (c), and (d) of FIG. 11 are diagrams for describing a unit in which capacitors are driven by the other touch panel system.

FIG. 12 Parts (a), (b), and (c) of FIG. 12 are diagrams for describing a method for inversely driving capacitors by the other touch panel system.

FIG. 13 is a diagram of waveforms of a drive signal and the like used when the other touch panel system performs 1st vector driving and then performs 2nd vector driving.

FIG. 14 Part (a) of FIG. 14 is a diagram of waveforms of a drive signal and the like used when the other touch panel system continuously performs 1st vector driving, and part (b) of FIG. 14 is a diagram of waveforms of a drive signal and the like used when the other touch panel system continuously performs phase 0 driving of 1st vectors.

FIG. 15 Part (a) of FIG. 15 is a diagram of waveforms of a drive signal and the like used when the other touch panel system continuously performs 1st vector driving, and part (b) of FIG. 15 is a diagram of waveforms of a drive signal and the like used when 1st vector driving is inversely performed for even-numbered times.

FIG. 16 Part (a) of FIG. 16 is a diagram of waveforms of a drive signal and the like used when phase 0 driving of 1st vectors is continuously performed, and part (b) of FIG. 16 is a diagram of waveforms of a drive signal and the like used when phase 0 driving of the 1st vectors is inversely performed for even-numbered times.

FIG. 17 Part (a) of FIG. 17 is a diagram of waveforms of a drive signal and the like used when the other touch panel system continuously performs 1st-to-3rd vector driving, and part (b) of FIG. 17 is a diagram of waveforms of a drive signal and the like used when 1st-to-3rd vector driving is inversely performed for even-numbered times.

FIG. 18 Parts (a) and (b) of FIG. 18 are graphs illustrating frequency characteristics of quadruple sampling performed by the other touch panel system.

FIG. 19 is a graph illustrating frequency characteristics of other kinds of quadruple sampling performed by the other touch panel system.

FIG. 20 Parts (a) and (b) of FIG. 20 are graphs illustrating frequency characteristics of yet other kinds of quadruple sampling performed by the other touch panel system.

FIG. 21 Parts (a) and (b) of FIG. 21 are diagrams for comparing the driving methods performed by the other touch panel system.

FIG. 22 is a circuit diagram illustrating a configuration of a touch panel system according to a second embodiment.

FIG. 23 is a block diagram illustrating a configuration of an electronic device according to a third embodiment.

### DESCRIPTION OF EMBODIMENTS

Embodiments of the present invention will be described in detail below.

### First Embodiment

### Configuration of Signal Processing System 10

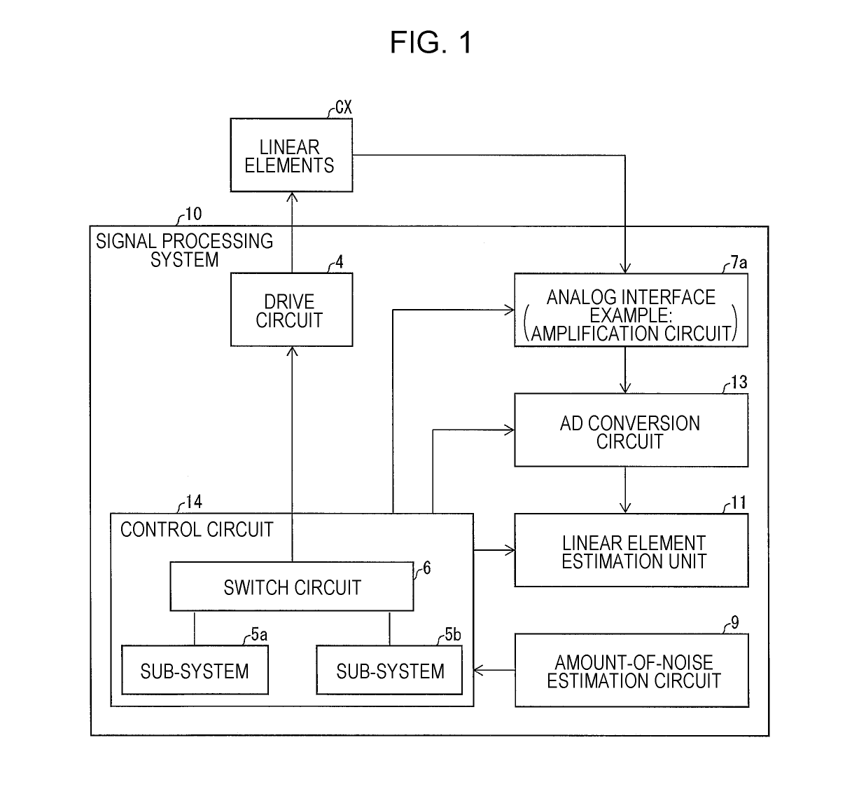

FIG. 1 is a block diagram illustrating a configuration of a signal processing system 10 according to a first embodiment. The signal processing system 10 includes a drive circuit 4 that drives linear elements CX and a control circuit 14 that controls the drive circuit 4.

The control circuit 14 includes sub-systems 5a and 5b having input/output transfer characteristics different from each other and a switch circuit 6 that connects one of the sub-systems 5a and 5b to the drive circuit 4.

Each of the linear elements CX is driven by the drive circuit 4, which is controlled by the sub-system 5a or 5b, and supplies an analog interface 7a (e.g., an amplification circuit) with a time-series signal having a value that can be observed continuously or discretely and that changes instantly. The analog interface 7a amplifies this time-series signal and outputs the amplified time-series signal to an AD conversion circuit 13. The AD conversion circuit 13 performs AD conversion on the time-series signal supplied from the analog interface 7a, and supplies a linear element estimation unit 11 with a plurality of time-series signals that are time-discretely sampled and that change instantly. The linear element estimation unit 11 performs addition-subtraction-based signal processing on the plurality of AD-converted time-series signals based on the linear element CX and estimates a value of the linear element CX or an input of the linear element CX. The signal processing system 10 includes an amount-of-noise estimation circuit 9 that estimates an amount of noise that mixes into the time-series signals, from the estimated value of the linear element CX or the estimated input value of the linear element CX obtained by the linear element estimation unit 11.

The switch circuit 6 switches between the sub-systems 5a and 5b and connects one of the sub-systems 5a and 5b to the drive circuit 4, based on input/output transfer characteristics and a frequency and an amount of noise mixing into the time-series signals so as to reduce noise mixing into the estimated result of the value or input of the linear element CX by performing addition-subtraction-based signal processing.

The control circuit 14 controls the analog interface circuit 7a. For example, the control circuit 14 controls a signal for even-numbered phase driving and odd-numbered phase driving between which the input state to the amplifier circuit is switched. The control circuit 14 also controls the sampling frequency and the number of multiple sampling used by the AD conversion circuit 13. The control circuit 14 further controls an operation of the linear element estimation unit 11.

The number of multiple sampling of the time-series signals from the linear element CX based on the sub-system 5a can be different from the number of multiple sampling of the time-series signals from the linear element CX based on the sub-system 5b. The sampling frequency of the time-series signals from the linear element CX based on the sub-system 5a can be different from the sampling frequency of the time-series signals from the linear element CX based on the sub-system 5b.

The positive/negative sign of the plurality of time-series signals based on the sub-systems 5a and 5b can invert with time. In addition, the positive/negative sign of the plurality of time-series signals based on the sub-systems 5a and 5b can be constant with time.

The switch circuit 6 switches between the sub-systems 5a and 5b on the basis of the estimated result obtained by the amount-of-noise estimation circuit 9.

The linear element CX can be, for example, a capacitor. The linear element CX may be a thermometer including a thermocouple. In this case, the signal processing system 10 can work even without the drive circuit 4. A configuration capable of reducing noise by amplifying, using an amplification circuit, a weak voltage (weak current) that can be observed with a thermocouple and then performing sampling using the AD conversion circuit 13 while changing the number of samples in multiple sampling and the sampling frequency can be implemented.

(Amount of Noise and Frequency Characteristics Between Sampling Frequency and Amount of Amplitude Change)

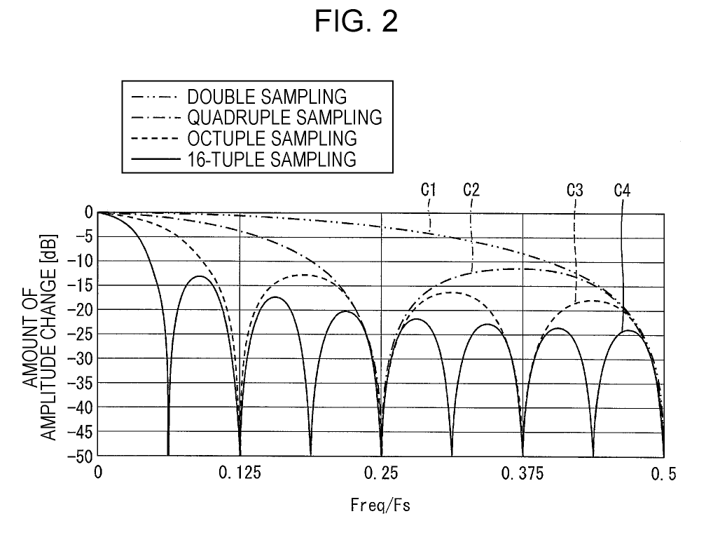

FIG. 2 is a graph illustrating an amount of noise of a time-series signal processed by the signal processing system 10 and a frequency characteristic between the sampling frequency and an amount of amplitude change of the time-series signal. The horizontal axis indicates a normalization coefficient, which is a ratio between the signal frequency and the sampling frequency. The vertical axis indicates an amount of amplitude change of the signal.

A characteristic C1 indicates a frequency characteristic of double sampling in which two signals are sampled and a simple moving average thereof is output. A characteristic C2 indicates a frequency characteristic of quadruple sampling in which four signals are sampled and a simple moving average thereof is output. A characteristic C3 indicates a frequency characteristic of octuple sampling in which eight signals are sampled and a simple moving average thereof is output. A characteristic C4 indicates a frequency characteristic of 16-tuple sampling in which 16 signals are sampled and a simple moving average thereof is output.

According to this graph of the frequency characteristic, as for double sampling, an amount of amplitude change is −∞ dB when the normalization coefficient is 0.5 as indicated by the characteristic C1. Accordingly, noise is successfully removed if the sampling frequency is set to be twice as high as the noise frequency. In addition, noise is successfully reduced if the sampling frequency is changed to make the normalized frequency close to 0.5.

As for quadruple sampling, an amount of amplitude change is −∞ dB when the normalization coefficient is 0.5 and 0.25 as indicated by the characteristic C2. Accordingly, noise is successfully removed if the sampling frequency is set to be twice or four times as high as the noise frequency. In addition, noise is successfully reduced if the sampling frequency is changed to make the normalized frequency close to 0.5 or 0.25.

As for octuple sampling, an amount of amplitude change is −∞ dB when the normalization coefficient is 0.5, 0.375, 0.25, and 0.125 as indicated by the characteristic C3. Accordingly, noise is successfully removed if the sampling frequency is set to be twice, 2.67 times, four times, or eight times as high as the noise frequency. In addition, noise is successfully reduced if the sampling frequency is changed to make the normalized frequency close to 0.5, 0.375, 0.25 or 0.125.

As for 16-tuple sampling, noise is successfully removed or reduced by setting or changing the sampling frequency as indicated by the characteristic C4, respectively.

As described above, noise is successfully removed or reduced by setting or changing the sampling frequency relative to the noise frequency.

For example, when the normalized frequency is 0.25, the amount of amplitude change is −3 dB for double sampling; whereas the amount of amplitude change is −∞ dB for quadruple sampling, octuple sampling, and 16-tuple sampling. Accordingly, if the number of multiple sampling is changed from double to any of quadruple, octuple, and 16-tuple, noise is successfully removed. In this way, noise is successfully removed or reduced also by changing the number of multiple sampling.

Therefore, the sampling frequency of the plurality of sub-systems illustrated in FIG. 1 are set differently or the number of multiple sampling thereof are set differently, and the sub-systems for which the number of multiple sampling or the sampling frequency are set to reduce the amount of amplitude change illustrated in FIG. 2 are switched between by the switch circuit 6 on the basis of the noise frequency. In this way, noise is successfully removed or reduced.

(Configuration of Touch Panel System 1]

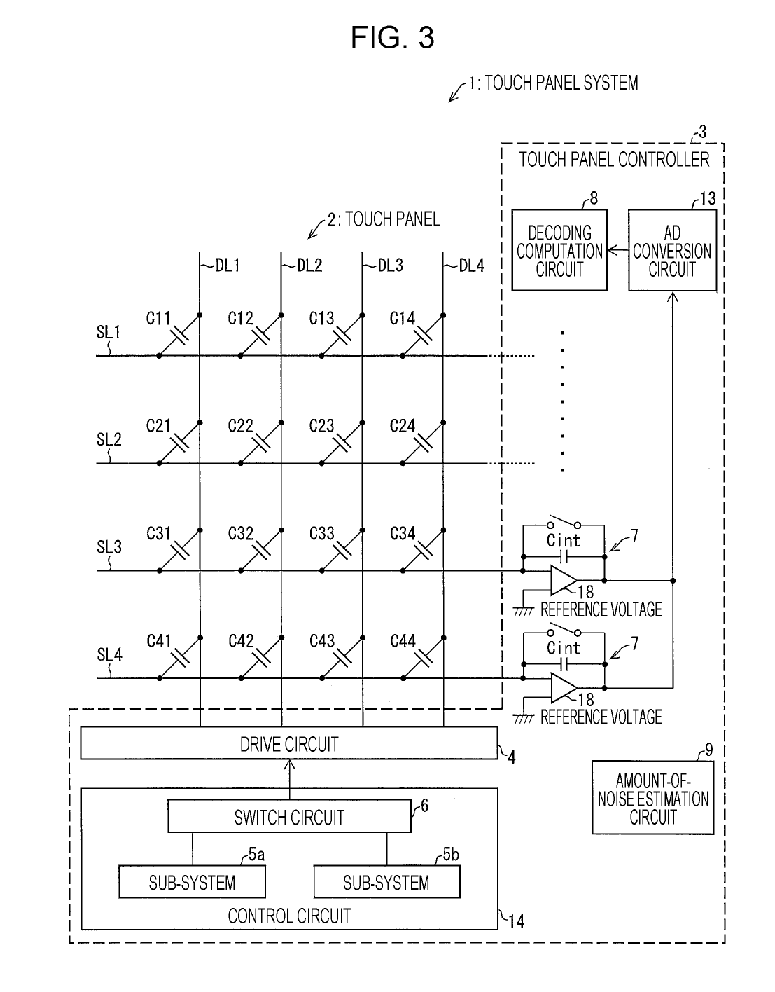

FIG. 3 is a circuit diagram illustrating a configuration of a touch panel system 1 according to the first embodiment. The touch panel system 1 includes a touch panel 2 and a touch panel controller 3. The touch panel 2 includes capacitors C11 to C44 disposed at respective intersection points of drive lines DL1 to DL4 and sense lines SL1 to SL4.

The touch panel controller 3 includes the drive circuit 4 that drives the capacitors C11 to C44 along the drive lines DL1 to DL4.

The touch panel controller 3 includes amplification circuits 7 each connected to a corresponding one of the sense lines SL1 to SL4. The amplification circuits 7 read a plurality of linear-sum signals based on capacitances accumulated in the respective capacitors C11 to C44 driven by the drive circuit 4 along the sense line SL1 to SL4 and amplify the plurality of linear-sum signals. The amplification circuits 7 each include an amplifier 18, and an integral capacitance Cint and a reset switch connected in parallel with the amplifier 18.

The touch panel controller 3 includes the AD conversion circuit 13 that performs analog-digital conversion on outputs of the amplification circuits 7 and a decoding computation circuit 8 that estimates a capacitance accumulated in each of the capacitors C11 to C44 on the basis of the analog-digital-converted outputs of the amplification circuits 7.

The touch panel controller 3 includes the control circuit 14 that controls the drive circuit 4. The control circuit 14 includes the sub-systems 5a and 5b having different input/output transfer characteristics and the switch circuit 6 that switches between the sub-systems 5a and 5b and connects one of the sub-systems 5a and 5b to the drive circuit 4 on the basis of a frequency and an amount of noise mixing into the linear-sum signals and the input/output transfer characteristics so as to reduce noise mixing into estimated results of the capacitances of the capacitors C11 to C44 obtained by the decoding computation circuit 8.

The control circuit 14 controls the sampling frequency and the number of multiple sampling used by the AD conversion circuit 13. Further, the control circuit 14 controls an operation of the decoding computation circuit 8.

The touch panel controller 3 also includes the amount-of-noise estimation circuit 9 that estimates an amount of noise mixing into the linear-sum signals, from estimated values of the capacitances obtained by addition-subtraction-based signal processing on the linear-sum signals. The switch circuit 6 switches between the sub-systems 5a and 5b on the basis of the estimation result obtained by the amount-of-noise estimation circuit 9.

(Operation of Touch Panel System 1)

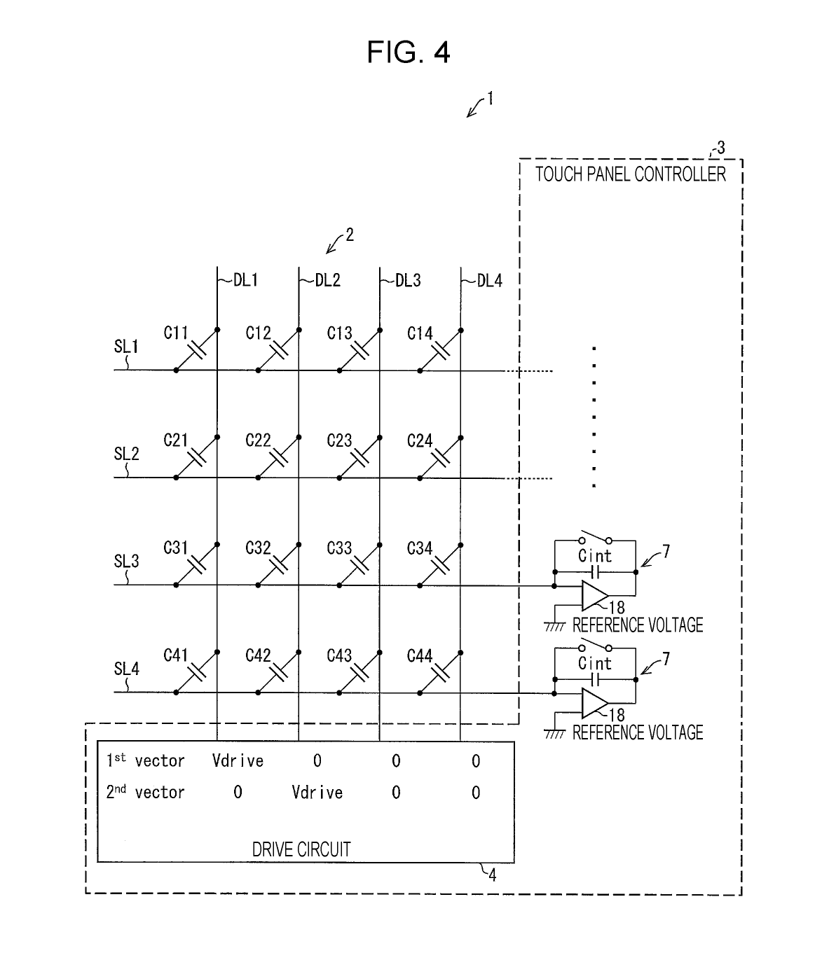

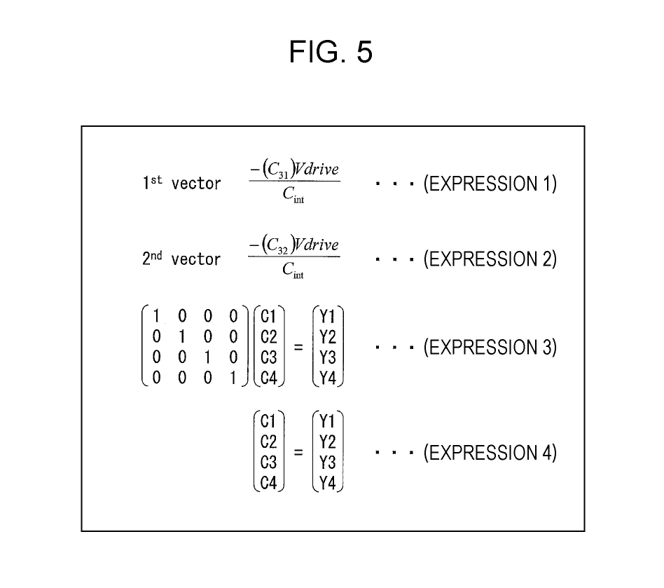

FIG. 4 is a circuit diagram for describing a driving method performed by the touch panel system 1. FIG. 5 is a diagram for describing mathematical expressions representing the driving method performed by the touch panel system 1.

The drive circuit 4 drives the drive lines DL1 to DL4 on the basis of a code sequence of 4 rows and 4 columns denoted by Expression 3 in FIG. 5. If an element of the code matrix is “1”, the drive circuit 4 applies a voltage Vdrive; whereas if an element is “0”, the drive circuit 4 applies zero volts.

The amplification circuits 7 receive and amplify measured linear-sum values Y1, Y2, Y3, and Y4 along the sense lines of capacitances based on electric charge accumulated in capacitors driven by the drive circuit 4.

For example, during first driving among driving that is performed four times using the code sequence of 4 rows and 4 columns, the drive circuit 4 applies the voltage Vdrive to the drive line DL1 and applies zero volts to the other drive lines DL2 to DL4. Then, for example, the measured value Y1 from the sense line SL3, which corresponds to the capacitor C31 accumulating a capacitance C₃₁ indicated by Expression 1 in FIG. 5, is output from the amplification circuit 7.

Then, during second driving, the drive circuit 4 applies the voltage Vdrive to the drive line DL2 and applies zero volts to the other drive lines DL1, DL3, and DL4. Then, the measured value Y2 from the sense line SL3, which corresponds to the capacitor C32 accumulating a capacitance C₃₂ indicated by Expression 2 in FIG. 5, is output from the amplification circuit 7.

Then, during third driving, the drive circuit 4 applies the voltage Vdrive to the drive line DL3 and applies zero volts to the other drive lines. Then, during fourth driving, the drive circuit 4 applies the voltage Vdrive to the drive line DL4 and applies zero volts to the other drive lines.

As a result, the measured values Y1, Y2, Y3, and Y4 are associated with the capacitance values C1, C2, C4, and C4, respectively, as indicated by Expressions 3 and 4 in FIG. 5. Note that a coefficient (−Vdrive/Cint) for the measured values Y1 to Y4 is omitted in Expressions 3 and 4 in FIG. 5 to simplify the notation.

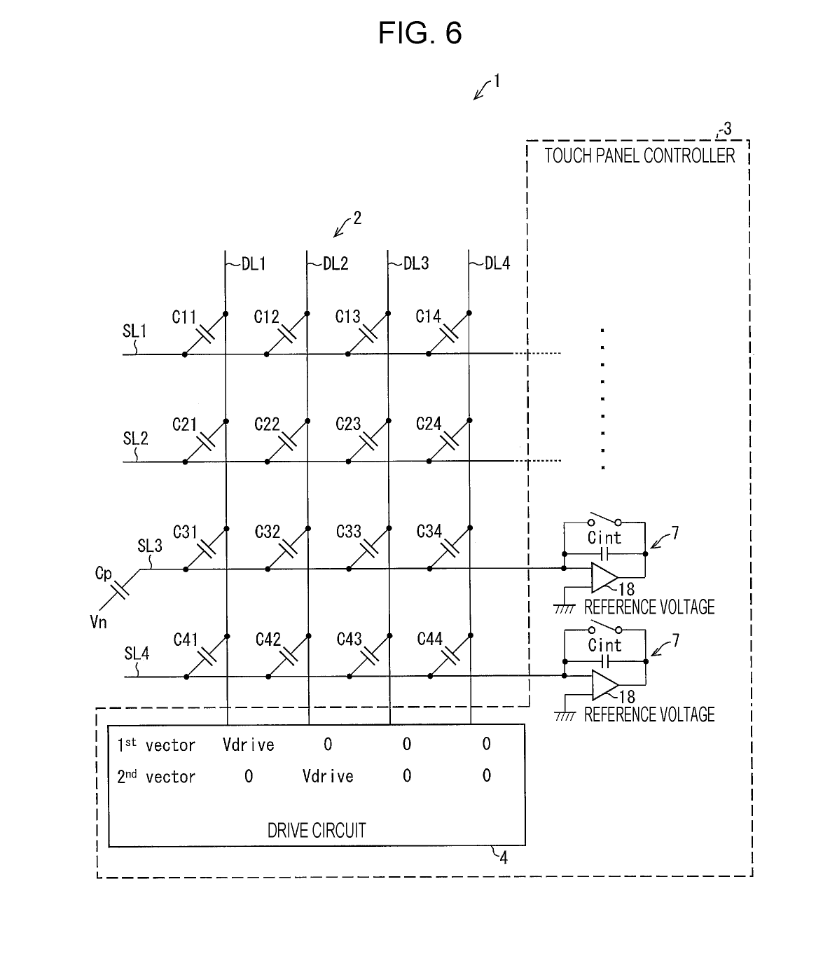

FIG. 6 is a circuit diagram illustrating a situation in which noise is applied to the touch panel system 1. The description will be given using the sense line SL3 as an example to simplify the explanation. If noise is applied via a parasitic capacitance Cp coupled to the sense line SL3 to a linear-sum signal read along the sense line SL3, the linear-sum signal is represented as follows:

(−C×Vdrive/Cint)+(Cp×Vn/Cint).

Accordingly, noise represented as

Ey=Cp×Vn/Cint

mixes into the linear-sum signal.

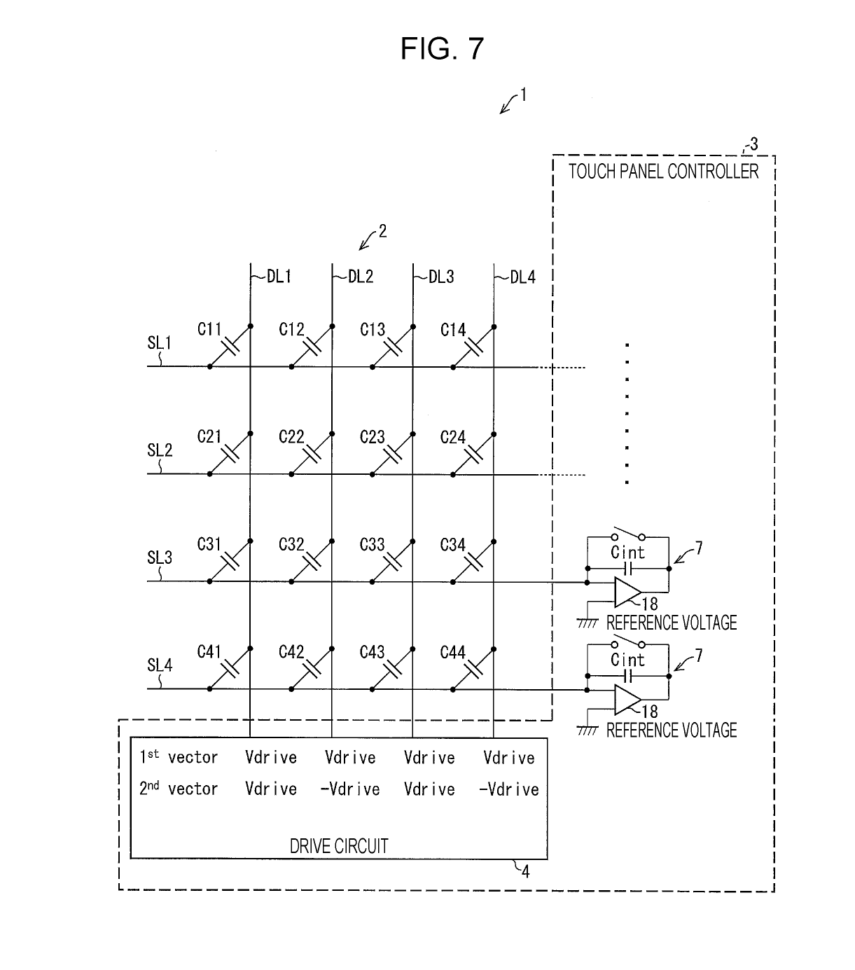

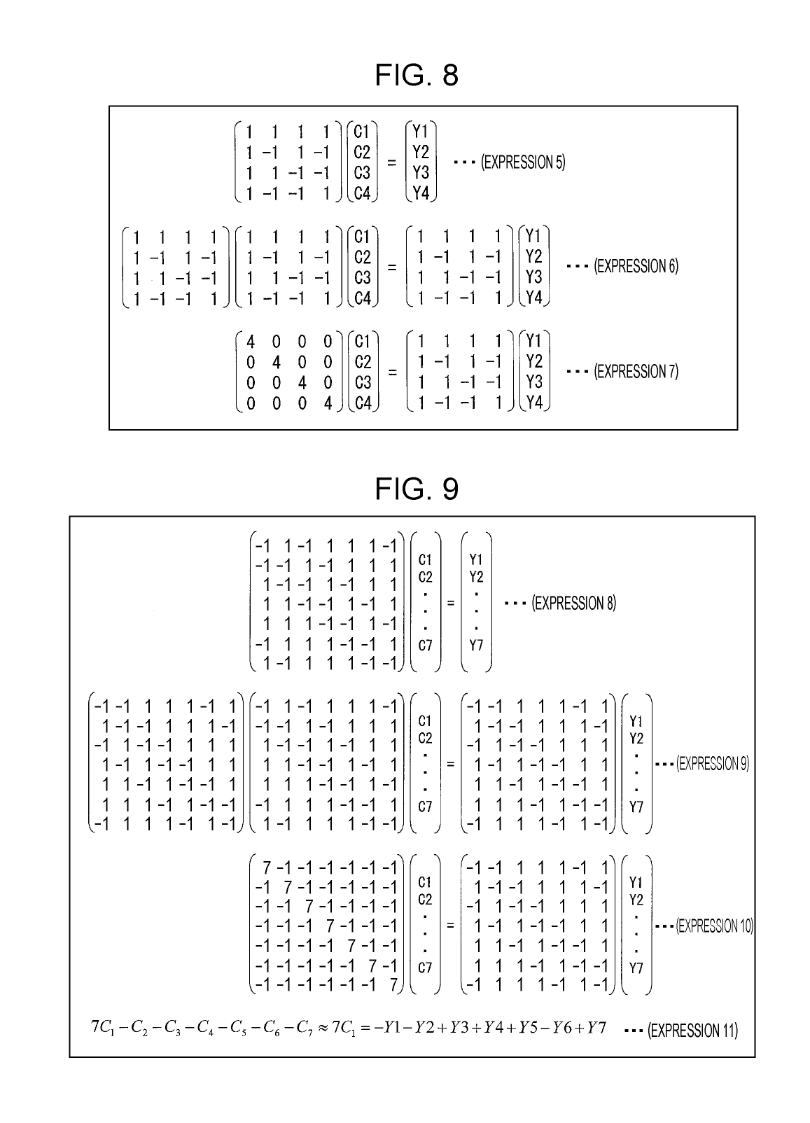

FIG. 7 is a circuit diagram for describing a parallel driving method performed by the touch panel system 1. FIG. 8 is a diagram for describing mathematical expressions representing the parallel driving method performed by the touch panel system 1.

The drive circuit 4 drives the drive lines DL1 to DL4 on the basis of an orthogonal code sequence of 4 rows and 4 columns represented by Expression 5 in FIG. 8. Each element of the orthogonal code sequence is either “1” or “−1”. If the element is “1”, a drive unit 54 applies the voltage Vdrive. If the element is “−1”, the drive unit 54 applies −Vdrive. Note that the voltage Vdrive may be a supply voltage or a voltage other than the supply voltage.

Then, the capacitances C1 to C4 are successfully estimated as indicated by Expression 7 by determining an inner product of the measured values Y1, Y2, Y3, and Y4 and the orthogonal code sequence as indicated by Expression 6 in FIG. 8.

Since noise is relatively large in the touch panel system, the above operation is sometimes performed a plurality of times and averaged linear-sum signal data is sometimes treated as a true value. The sub-systems 5a and 5b (see FIG. 3) having different input/output transfer characteristics are successfully implemented by changing a timing of this operation performed a plurality of times.

FIG. 9 is a diagram for describing mathematical expressions representing the parallel driving method performed by the touch panel system 1 using an M-sequence code. Capacitances of the capacitors are also successfully estimated by performing parallel driving on the capacitors using the M-sequence code. The capacitances C1 to C7 are successfully estimated by determining an inner product of the measured values Y1 to Y7 as indicated by Expressions 8 to 11. The “M-sequence” is a kind of a binary pseudo random number sequence and includes only two values of 1 and −1 (or 1 and 0). The length of one period of the M-sequence is 2ⁿ−1. Examples of the M-sequence having a length=2³−1=7 include “1, −1, −1, 1, 1, 1, −1”.

(Configuration of Touch Panel System 1a)

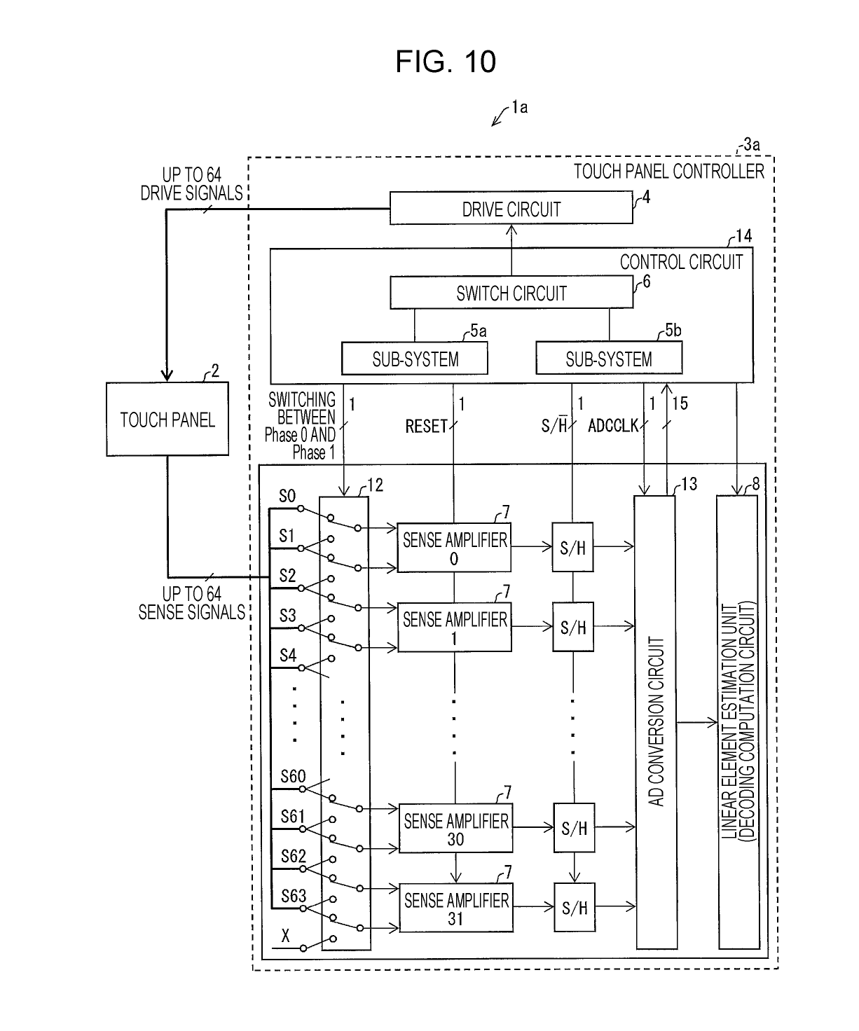

FIG. 10 is a circuit diagram illustrating a configuration of another touch panel system 1a according to the first embodiment. Components that are the same as those described before in FIG. 3 are assigned the same reference signs. Accordingly, a detailed description of these components is omitted.

The touch panel system 1a includes a touch panel controller 3a. The touch panel controller 3a includes a switch circuit 12. The switch circuit 12 switches the input state of each amplification circuit (sense amplifier) 7 between an even-numbered phase state (phase 0) in which a 2n-th sense line and a (2n+1)-th sense line are input and an odd-numbered phase state (phase 1) in which the (2n+1)-th sense line and a (2n+2)-th sense line are input. Here, n is an integer greater than or equal to zero and less than or equal to 31.

The control circuit 14 controls the amplification circuits 7. For example, the control circuit 14 controls a signal supplied to the switch circuit 12 and corresponding to even-numbered phase driving and odd-numbered phase driving between which the input state to the amplification circuits 7 is switched, for example. The control circuit 14 also controls the sampling frequency and the number of multiple sampling used in the AD conversion circuit 13. The control circuit 14 further controls an operation of the decoding computation circuit 8.

(Driving Methods by Touch Panel System 1a)

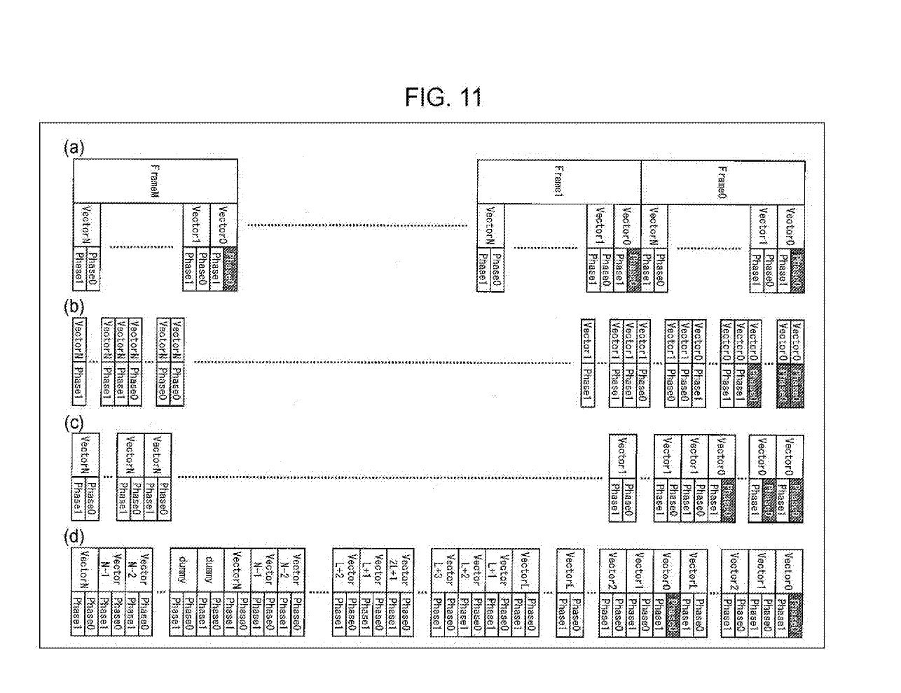

Parts (a), (b), (c), and (d) of FIG. 11 are diagrams for describing a unit in which the other touch panel system 1a drives the capacitors.

Part (a) of FIG. 11 is a diagram for describing frame-by-frame driving in which capacitors are driven in units of frames. The touch panel system 1a repeatedly performs (M+1) frame driving Flame0 to FlameM in this order. Each of the frame driving Flame0 to FlameM includes (N+1) vector driving Vector0 to VectorN. Each of the vector driving Vector0 to VectorN includes even-numbered phase driving Phase0 and odd-numbered phase driving Phase1.

The even-numbered phase driving Phase0 of the vector driving Vector0 included in the frame driving Flame0 to FlameM illustrated in part (a) of FIG. 11 (denoted as “Phase0” that is hatched in part (a) of FIG. 11) corresponds to “a plurality of time-series signals time-discretely sampled based on a linear element” recited in the claims.

Part (b) of FIG. 11 is a diagram for describing phase continuous driving in which capacitors are continuously driven using an identical phase. First, the capacitors are driven by continuously performing only the phase driving Phase0 of the vector driving Vector0 included in the frame driving Flame0 to FlameM in an order of the phase driving Phase0 included in the vector driving Vector0 of the frame driving Flame0, the phase driving Phase0 included in the vector driving Vector0 of the frame driving Flame1, the phase driving Phase0 included in the vector driving Vector0 of the frame driving Flame2, . . . , and the phase driving Phase0 included in the vector driving Vector0 of the frame driving FlameM.

Then, the capacitors are driven by continuously performing only the phase driving Phase1 of the vector driving Vector0 included in the frame driving Flame0 to FlameM in an order of the phase driving Phase1 included in the vector driving Vector0 of the frame driving Flame0, the phase driving Phase1 included in the vector driving Vector0 of the frame driving Flame1, the phase driving Phase1 included in the vector driving Vector0 of the frame driving Flame2, . . . , and the phase driving Phase1 included in the vector driving Vector0 of the frame driving FlameM.

Then, the capacitors are driven by continuously performing only the phase driving Phase0 of the vector driving Vector1 included in the frame driving Flame0 to FlameM in an order of the phase driving Phase0 included in the vector driving Vector1 of the frame driving Flame0, the phase driving Phase0 included in the vector driving Vector1 of the frame driving Flame1, the phase driving Phase0 included in the vector driving Vector1 of the frame driving Flame2, . . . , and the phase driving Phase0 included in the vector driving Vector1 of the frame driving FlameM. Thereafter, driving is similarly performed up to the vector driving VectorN.

Part (c) of FIG. 11 is a diagram for describing identical-vector continuous driving in which capacitors are driven continuously using identical vectors. First, the capacitors are driven by continuously performing only the vector driving Vector0 included in the frame driving Flame0 to FlameM in an order of the vector driving Vector0 of the frame driving Flame0, the vector driving Vector0 of the frame driving Flame1, the vector driving Vector0 of the frame driving Flame2, . . . , and the vector driving Vector0 of the frame driving FlameM.

Then, the capacitors are driven by continuously performing only the vector driving Vector1 included in the frame driving Flame0 to FlameM in an order of the vector driving Vector1 of the frame driving Flame0, the vector driving Vector1 of the frame driving Flame1, the vector driving Vector1 of the frame driving Flame2, . . . , and the vector driving Vector1 of the frame driving FlameM.

Then, the capacitors are driven by continuously performing only the vector driving Vector2 included in the frame driving Flame0 to FlameM in an order of the vector driving Vector2 of the frame driving Flame0, the vector driving Vector2 of the frame driving Flame1, the vector driving Vector2 of the frame driving Flame2, . . . , and the vector driving Vector2 of the frame driving FlameM. Thereafter, driving is similarly performed up to the vector driving VectorN.

Part (d) of FIG. 11 is a diagram for describing a plurality-of-vector continuous driving in which capacitors are driven continuously using a plurality of vectors. Driving is performed using L+1 consecutive vectors as one unit. Here, L is an integer that satisfies 1≦L≦(N−1).

First, the capacitors are driven by continuously performing only the vector driving Vector0 to L included in the frame driving Flame0 to FlameM in an order of the vector driving Vector0 to L of the frame driving Flame0, the vector driving Vector0 to L of the frame driving Flame1, the vector driving Vector0 to L of the frame driving Flame2, . . . , and the vector driving Vector0 to L of the frame driving FlameM.

Then, the capacitors are driven by continuously performing only the vector driving VectorL+1 to 2L+1 included in the frame driving Flame0 to FlameM in an order of the vector driving VectorL+1 to 2L+1 of the frame driving Flame0, the vector driving VectorL+1 to 2L+1 of the frame driving Flame1, the vector driving VectorL+1 to 2L+1 of the frame driving Flame2, . . . , and the vector driving VectorL+1 to 2L+1 of the frame driving FlameM.

Then, the capacitors are driven by continuously performing only the vector driving Vector2L+2 to 3L+2 included in the frame driving Flame0 to FlameM in an order of the vector driving Vector2L+2 to 3L+2 of the frame driving Flame0, the vector driving Vector2L+2 to 3L+2 of the frame driving Flame1, the vector driving Vector2L+2 to 3L+2 of the frame driving Flame2, . . . , and the vector driving Vector3L+2 of the frame driving FlameM. Thereafter, driving is similarly continued up to the vector driving VectorN included in the frame driving FlameM.

If the number of consecutive vectors is not L+1 during driving in which the vector driving VectorN included in Flame0 to FlameM−1 appears, dummy driving may be performed as many times as the shortage or a blank period equivalent to the shortage may be provided.

In addition, in the case of L=0, the plurality-of-vector continuous driving is the same as the identical-vector continuous driving illustrated in part (c) of FIG. 11. In the case of L=N, the plurality-of-vector continuous driving is the same as the frame-by-frame driving illustrated in part (a) of FIG. 11.

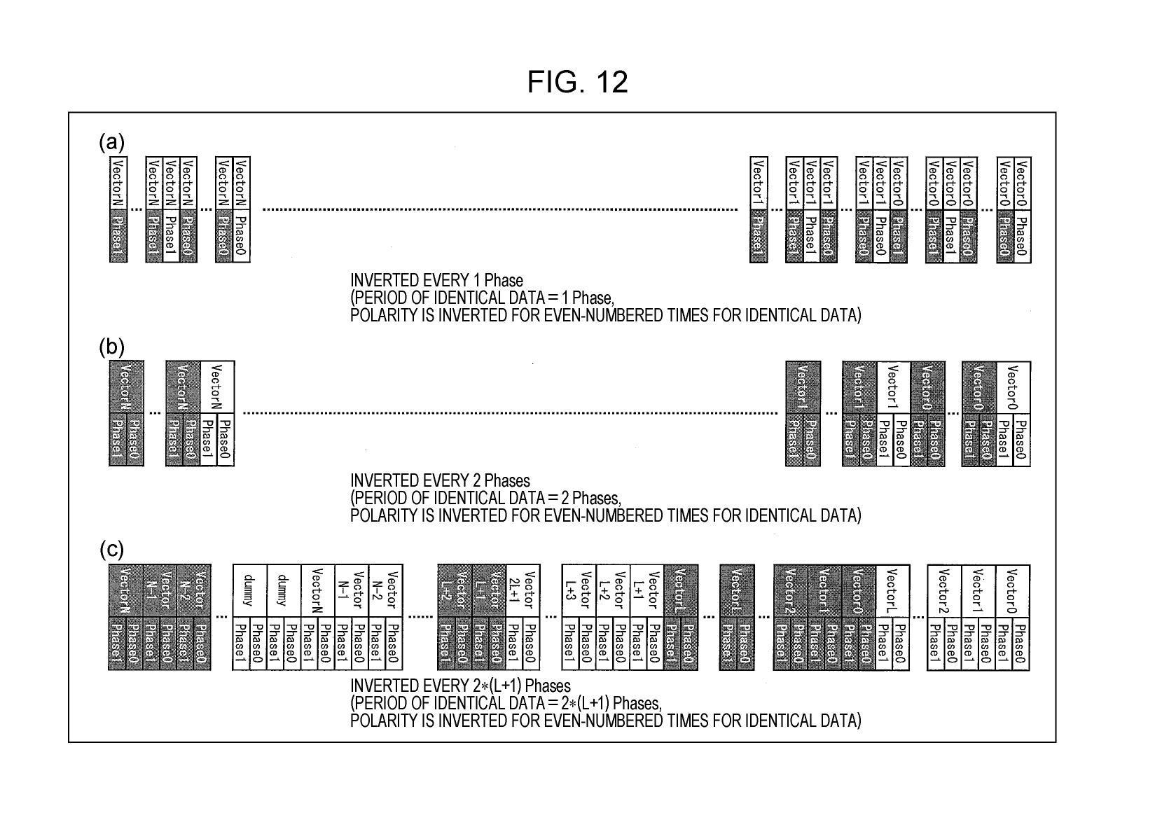

Parts (a), (b), and (c) of FIG. 12 are diagrams for describing a method for inversely driving the capacitors by the touch panel system 1a.

Part (a) of FIG. 12 is an example of phase continuous inverted driving (part where inverted driving is performed is denoted by white letters with black background) in which driving is inversely performed for even-numbered times in the phase continuous driving illustrated in part (b) of FIG. 11. First, the phase driving Phase0 included in the vector driving Vector0 of the frame driving Flame0 is performed. Then, the phase driving Phase0 included in the vector driving Vector0 of the frame driving Flame1 is inversely performed.

Then, the phase driving Phase0 included in the vector driving Vector0 of the frame driving Flame2 is performed. Then, the phase driving Phase0 included in the vector driving Vector0 of the frame driving Flame3 is inversely performed.

Inversion in the phase continuous inverted driving is performed on a one-phase-driving basis. An acquisition period of identical data for an averaging process is a period corresponding to one phase driving. The polarity of this identical data inverts for even-numbered times.

Part (b) of FIG. 12 illustrates identical-vector continuous inverted driving (part where even-numbered inverted driving is performed is denoted by white letters with black background) in which two phase driving for even-numbered times are inversely performed in the identical-vector continuous driving illustrated in part (c) of FIG. 11. First, the vector driving Vector0 of the frame driving Flame0 is performed. Then, the vector driving Vector0 of the frame driving Flame1 is inversely performed. Then, the vector driving Vector0 of the frame driving Flame2 is performed. Then, the vector driving Vector0 of the frame driving Flame3 is inversely performed.

Inversion in the identical-vector continuous inverted driving is performed on a two-phase-driving basis. The acquisition period of identical data for the averaging process is a period corresponding to two phase driving. In the identical-vector continuous inverted driving, the polarity inverts for two phase driving of even-numbered times.

Part (c) of FIG. 12 illustrates a plurality-of-vector continuous inverted driving (part where even-numbered inverted driving is performed is denoted by white letters with black background) in which plurality-of-vector driving for even-numbered times is inversely performed in the plurality-of-vector continuous driving illustrated in part (d) of FIG. 11. First, the vector driving Vector0 to L of the frame driving Flame0 is performed. Then, the vector driving Vector0 to L of the frame driving Flame1 is inversely performed. Then, the vector driving Vector0 to L of the frame driving Flame 2 is performed. Then, the vector driving Vector0 to L of the frame driving Flame3 is inversely performed.

Inversion in the plurality-of-vector continuous inverted driving is performed on a 2×(L+1)-phase-driving basis. The acquisition period of identical data for the averaging process is a period corresponding to 2×(L+1) phase driving. In the plurality-of-vector continuous inverted driving, the polarity inverts for (2×(L+1)) phase driving for even-numbered times.

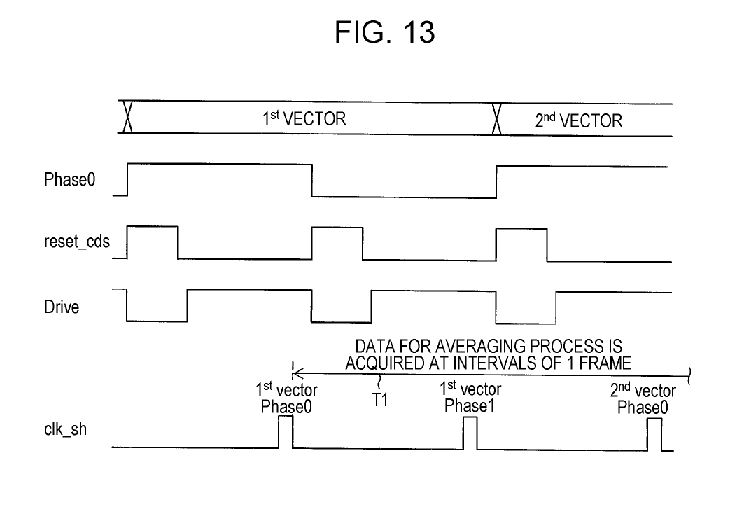

FIG. 13 is a diagram of waveforms of a drive signal and the like used when the touch panel system 1a performs 1st vector driving and then performs 2nd vector driving. A waveform diagram is shown that corresponds to the phase driving Phase0 of the vector driving Vector0 and the vector driving Vector1 of the frame-by-frame driving illustrated in part (a) of FIG. 11. When the signal Phase0 is ON, the even-numbered phase driving Phase0 is performed. When the signal Phase0 is OFF, the odd-numbered phase driving Phase1 is performed. When a reset signal reset_cds is ON, the amplification circuits 7 are reset. When a drive signal Drive becomes ON, the capacitors C11 and C44 are driven. When a clock signal clk_sh is ON, a linear-sum signal is read along each sense line. The linear-sum signal based on the even-numbered phase driving Phase0 of the vector driving Vector0 is acquired at intervals of a one frame (period T1).

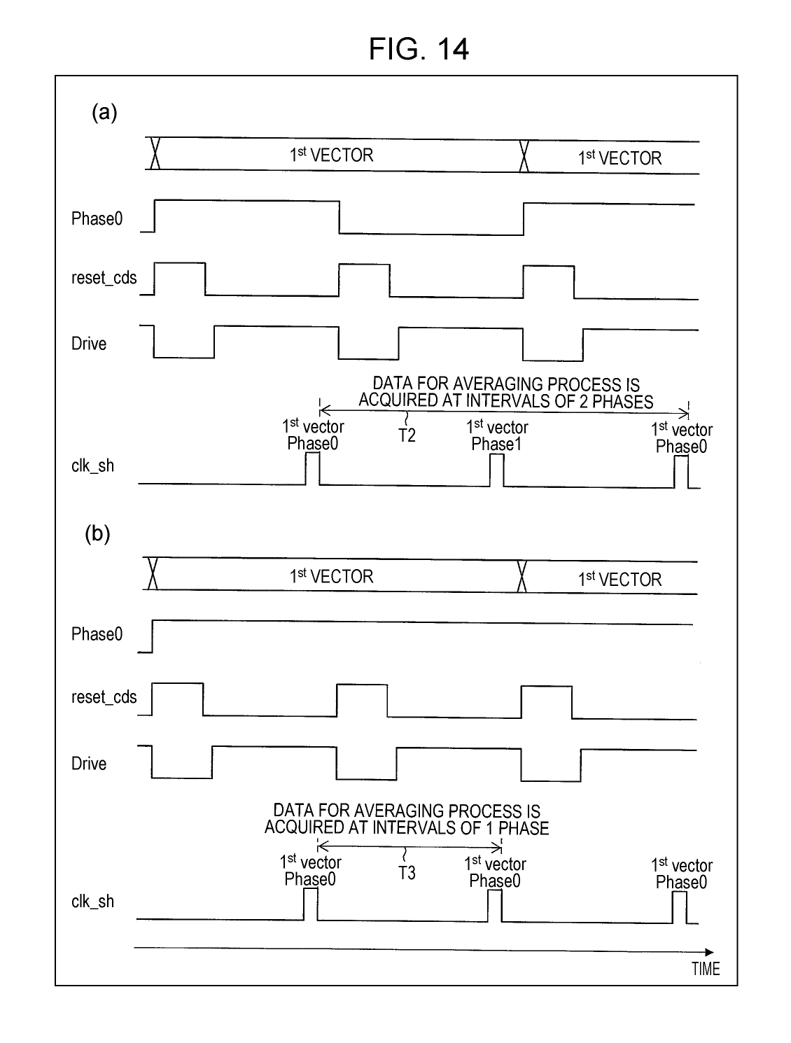

Part (a) of FIG. 14 is a diagram of waveforms of a drive signal and the like used when the touch panel system 1a continuously performs 1st vector driving. Part (b) of FIG. 14 is a diagram of waveforms of a drive signal and the like used when Phase0 driving of the 1st vectors is continuously performed.

In the case of the identical-vector continuous driving in which the vector driving Vector0 (1st vector) is continuously performed as illustrated in part (c) of FIG. 11, the linear-sum signals based on the vector driving Vector0 are acquired at intervals of two phases (period T2) as illustrated in part (a) of FIG. 14.

In the case of phase continuous driving in which the phase driving Phase0 included in the vector driving Vector0 (1st vectors) is continuously performed as illustrated in part (b) of FIG. 11, the linear-sum signals based on the phase driving Phase0 are acquired at intervals of one phase (period T3) as illustrated in part (b) of FIG. 14.

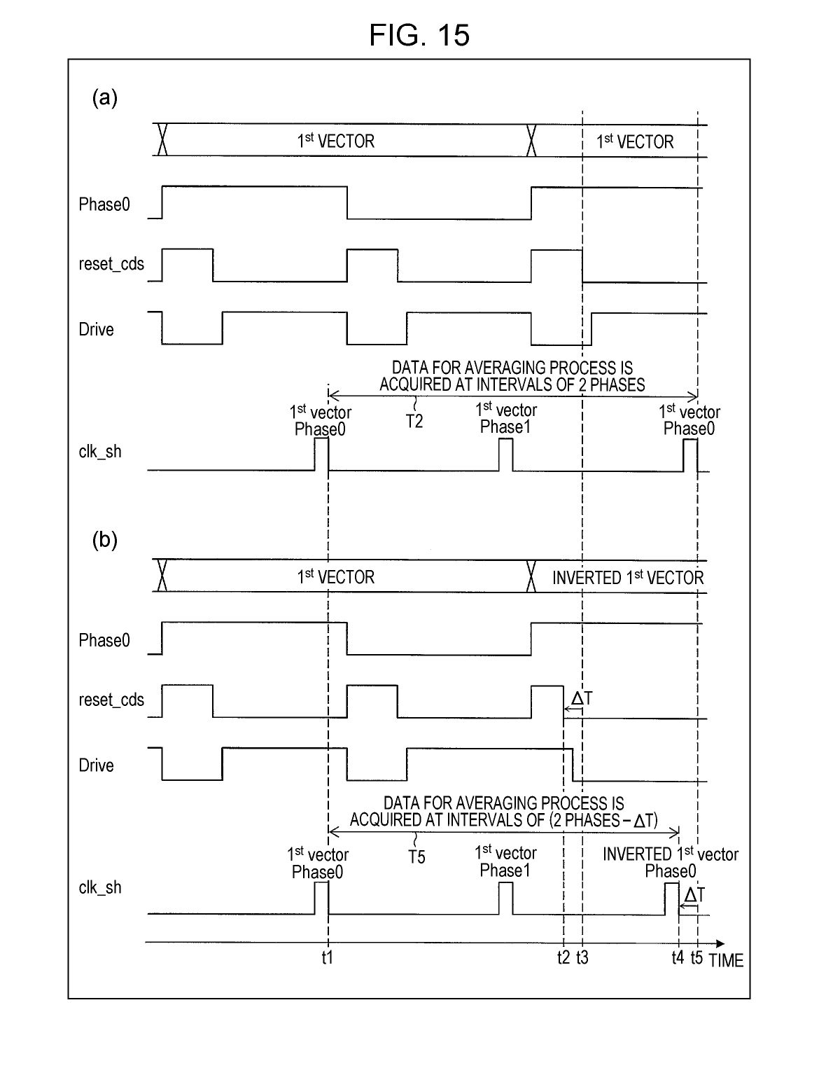

Part (a) of FIG. 15 is a diagram of waveforms of a drive signal and the like used when the touch panel system 1a continuously performs the 1st vector driving. Part (b) of FIG. 15 is a diagram of waveforms of a drive signal and the like used when the 1st vector driving is inversely performed for even-numbered times.

As illustrated in part (a) of FIG. 15, when the reset signal reset_cds rises, the drive signal Drive falls. After the reset signal reset_cds falls at time t3, the drive signal Drive rises.

As illustrated in part (b) of FIG. 15, inverted driving is performed by making the drive signal Drive fall from high to low. Accordingly, it is not necessary to make the drive signal Drive fall as illustrated in part (a) of FIG. 15 when the reset signal rises. Consequently, falling of the reset signal before inverted driving can be done at time t2, which is earlier than the time t3, at which the reset signal falls in part (a) of FIG. 15, by ΔT, and a reset period for which the reset signal reset_cds is ON can be shortened by ΔT. The linear-sum signal based on the vector driving Vector0 is acquired at intervals of two phases (period T2 from time t1 to time t5) in part (a) of FIG. 15, whereas the linear-sum signal can be acquired at intervals of (two phases−ΔT) (period T5 from time t1 to time t4).

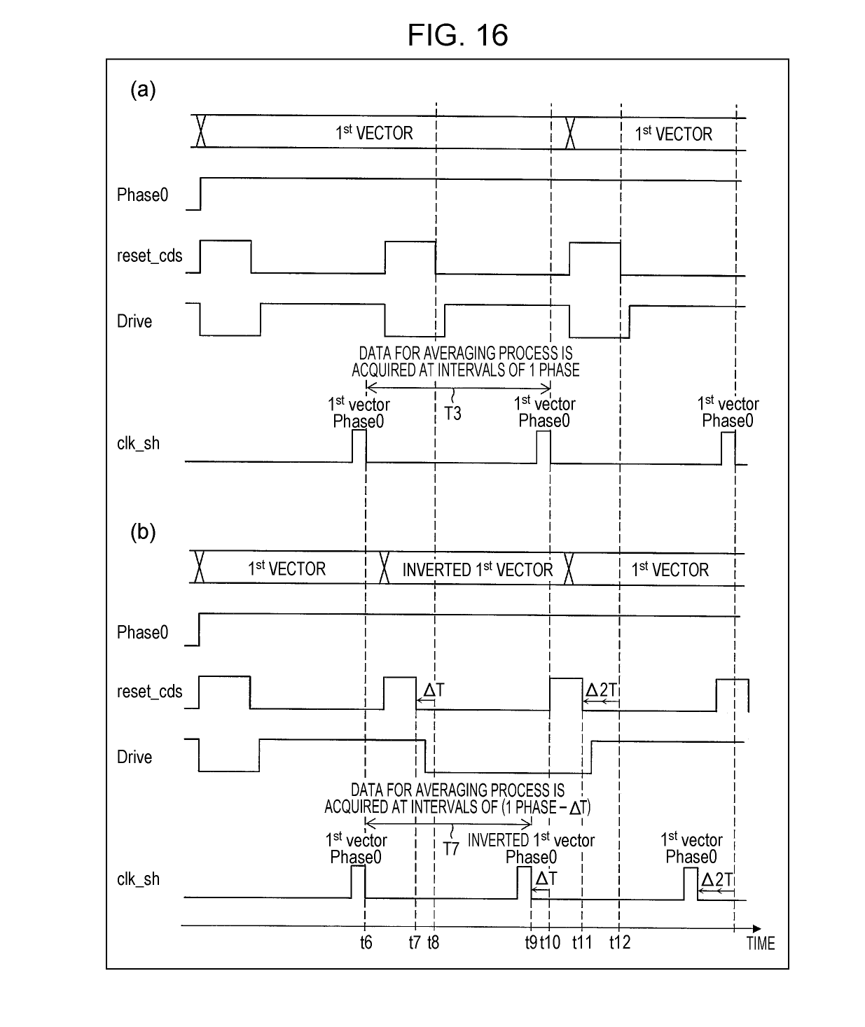

Part (a) of FIG. 16 is a diagram of waveforms of a drive signal and the like used when driving Phase0 of the 1st vectors is continuously performed. Part (b) of FIG. 16 is a diagram of waveforms of a drive signal and the like used when driving Phase0 of the 1st vectors is inversely performed for even-numbered times.

Referring to part (b) of FIG. 16, falling of the reset signal before inverted driving can be done at time t7, which is earlier than time t8, at which the reset signal falls in part (a) of FIG. 16, by ΔT, and the reset period for which the reset signal reset_cds is ON can be shortened by ΔT. Also, the following falling of the reset signal can be done at time t11, which is earlier than time t12, at which the reset signal falls in part (a) of FIG. 16, by Δ2T in total.

The linear-sum signal based on the phase driving Phase0 of the vector driving Vector0 is acquired at intervals of one phase (period T3 from time t6 to time t10) in the example in part (a) of FIG. 16, whereas the linear-sum signal can be acquired at intervals of (one phase−ΔT) (period T7 from time 6 to time 9) in part (b) of FIG. 16.

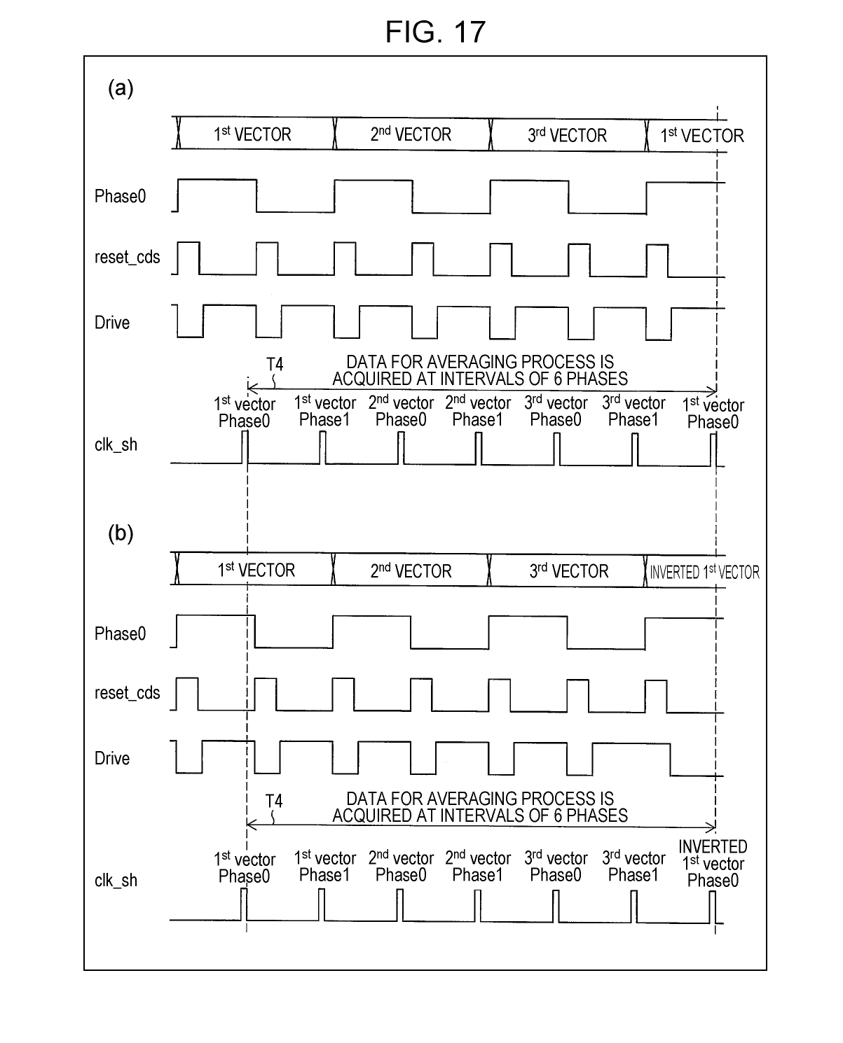

Part (a) of FIG. 17 is a diagram of waveforms of a drive signal and the like used when the touch panel system 1a continuously performs 1st-to-3rd vector driving. Part (b) of FIG. 17 is a diagram of waveforms of a drive signal and the like used when the 1st vector driving is inversely performed for even-numbered times.

In the case of L=2 in the plurality-of-vector continuous driving illustrated in part (d) of FIG. 11, Vector0 (1st vector) to Vector2 (3rd vector) are continuously performed. The linear-sum signal based on the vector driving Vector0 is acquired at intervals of six phases (period T4) as illustrated in part (a) of FIG. 17.

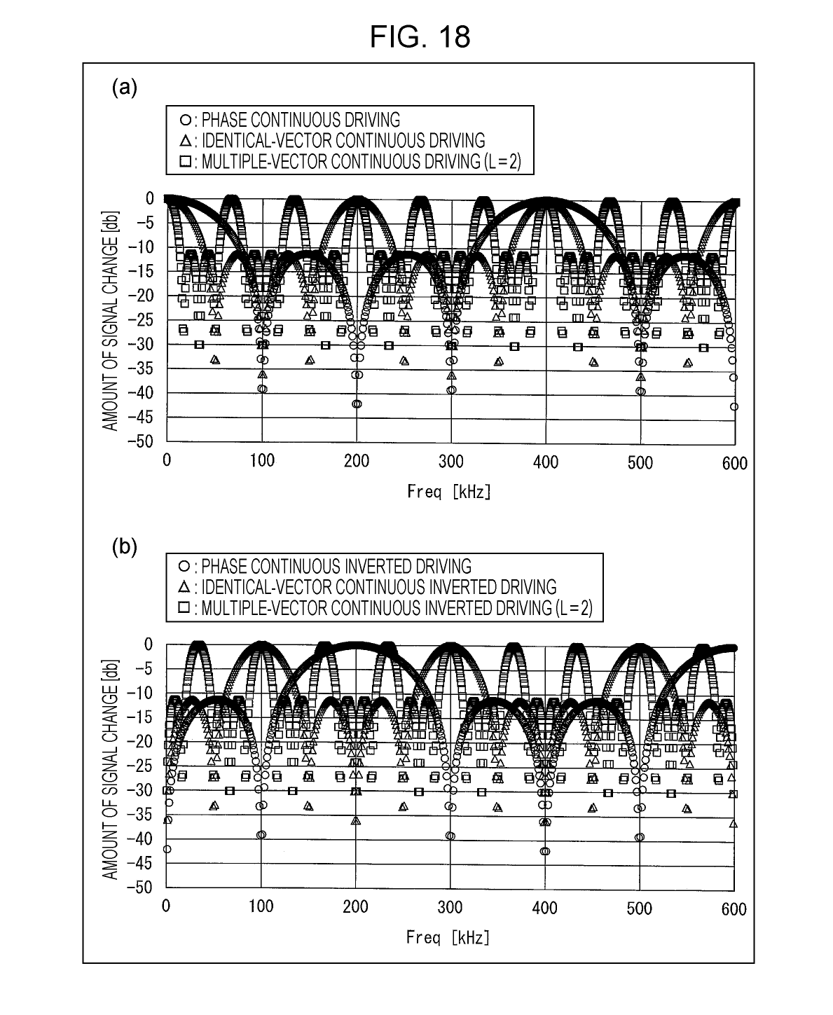

Parts (a) and (b) of FIG. 18 are graphs illustrating frequency characteristics of quadruple sampling performed by the touch panel system 1a. The horizontal axis denotes frequency, whereas the vertical axis denotes an amount of signal change. In each graph, a period of one phase is 2.5 μsec.

Part (a) of FIG. 18 illustrates a frequency characteristic obtained when phase driving is continuously performed (phase continuous driving illustrated in part (b) of FIG. 11), a frequency characteristic obtained when vector driving is continuously performed (identical-vector continuous driving illustrated in part (c) of FIG. 11), and a frequency characteristic obtained when driving is continuously performed using three vectors as a unit (plurality-of-vector continuous driving (L=2) illustrated in part (d) of FIG. 11), the frequency characteristics being obtained in the case where inverted driving is not performed.

Part (b) of FIG. 18 illustrates a frequency characteristic (phase continuous inverted driving illustrated in part (a) of FIG. 12) obtained when phase driving is continuously performed, a frequency characteristic (identical-vector continuous inverted driving illustrated in part (b) of FIG. 12) obtained when vector driving is continuously performed, and a frequency characteristic obtained when driving is performed in units of three vectors (plurality-of-vector continuous inverted driving (L=2) illustrated in part (c) of FIG. 12), the frequency characteristics being obtained in the case where inverted driving is performed and a reset-signal reduction period ΔT=0.0 μsec.

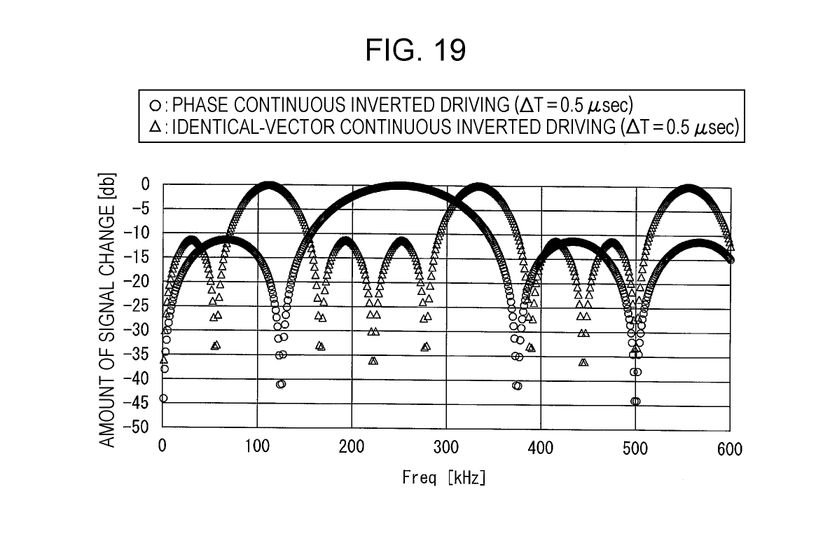

FIG. 19 illustrates a frequency characteristic (phase continuous inverted driving illustrated in part (a) of FIG. 12) obtained when phase driving is continuously performed and a frequency characteristic (identical-vector continuous inverted driving illustrated in part (b) of FIG. 12) in which vector driving is continuously performed, the frequency characteristics being obtained in the case where inverted driving is performed and the reset-signal reduction time ΔT=0.5 μsec.

These graphs illustrated in FIGS. 18 and 19 indicate that a frequency band for which the amount of signal change is approximately 0 dB is weak to noise and that a frequency band with a smaller amount of signal change is more robust to noise. Since there is no frequency band for which the amount of signal change is 0 dB under any condition in the examples illustrated in FIGS. 18 and 19, it can be expected that noise is suppressed by changing the sampling operation if there is one noise frequency. Note that the operation speed (report rate) does not decrease under this sampling condition if there is no dummy driving period or blank period in the plurality-of-vector continuous driving.

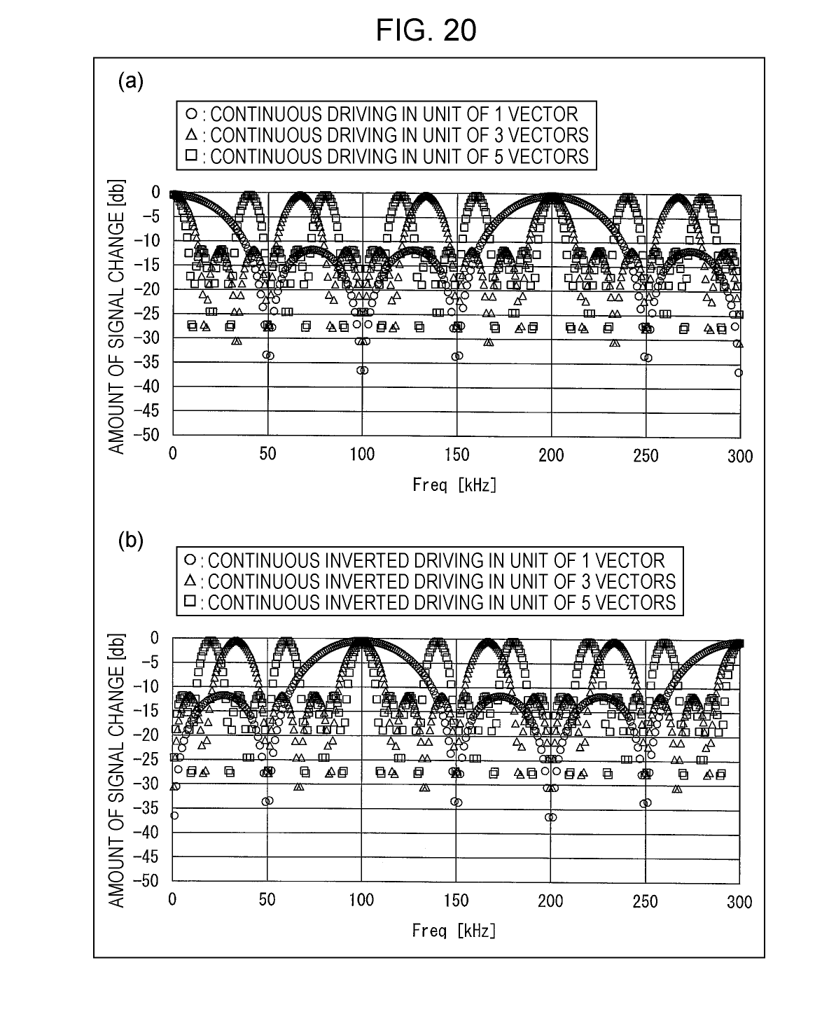

FIG. 20 shows graphs illustrating frequency characteristics for other kinds of quadruple sampling performed by the touch panel system 1a. In each graph, a period of one phase is 2.5 μsec.

Part (a) of FIG. 20 illustrates a frequency characteristic obtained when driving is continuously performed in unit of one vector (identical-vector continuous driving illustrated in part (c) of FIG. 11), a frequency characteristic obtained when driving is continuously performed in unit of three vectors (plurality-of-vector continuous driving (L=2) illustrated in part (d) of FIG. 11), and a frequency characteristic obtained when driving is continuously performed in unit of five vectors (plurality-of-vector continuous driving (L=4) illustrated in part (d) of FIG. 11), the frequency characteristics being obtained in the case where inverted driving is not performed.

Part (b) of FIG. 20 illustrates a frequency characteristic obtained when driving is continuously performed in unit of one vector (identical-vector continuous driving illustrated in part (c) of FIG. 11), a frequency characteristic obtained when driving is continuously performed in unit of three vectors (plurality-of-vector continuous driving (L=2) illustrated in part (d) of FIG. 11), and a frequency characteristic obtained when driving is continuously performed in unit of five vectors (plurality-of-vector continuous driving (L=4) illustrated in part (d) of FIG. 11), the frequency characteristics being obtained in the case where inverted driving is performed.

In the example illustrated in FIG. 20, the interval between a frequency band with a poor attenuation characteristic and a frequency band with a good attenuation characteristic narrows as the number of consecutive vectors used as a unit increases. If the frequency of noise desired to be removed is in a low frequency region, it can be expected that noise is suppressed by changing the number of consecutive vectors used as a unit. Note that the operation speed (report rate) does not decrease under this sampling condition if there is no dummy driving period or blank period in the plurality-of-vector continuous driving.

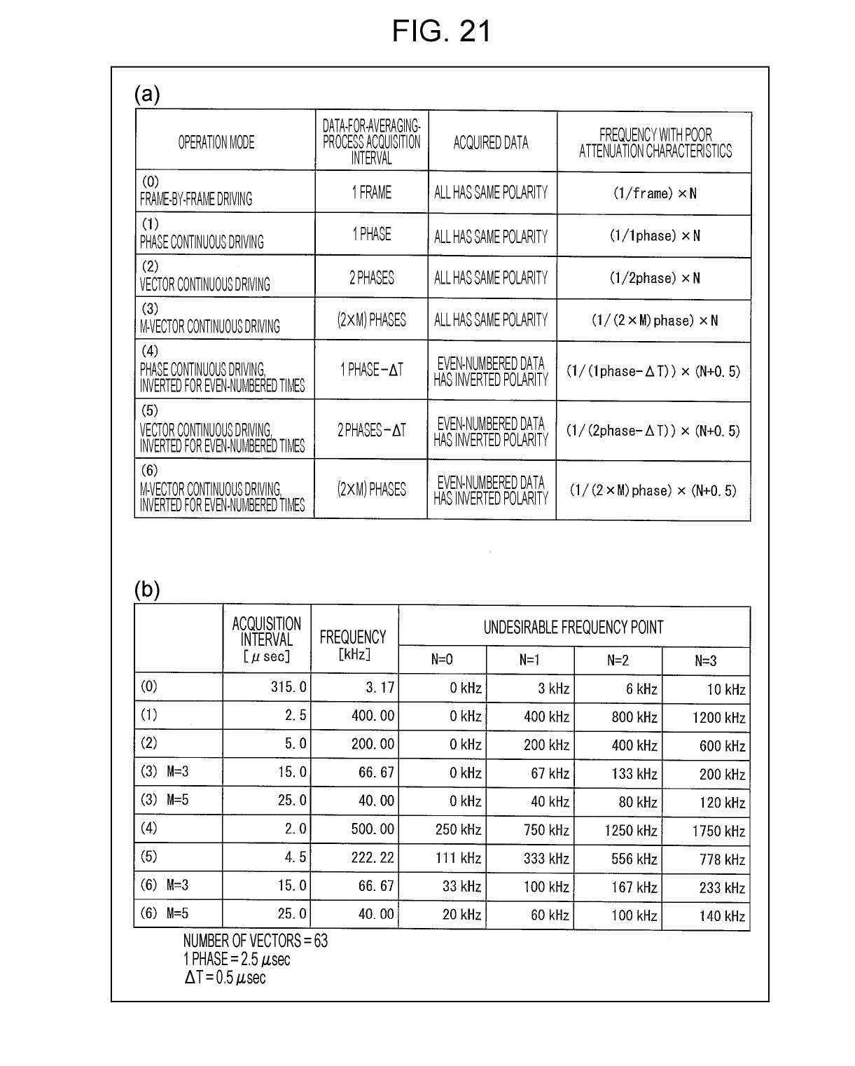

Parts (a) and (b) of FIG. 21 are diagrams for comparing the driving methods performed by the touch panel system 1a.

In an operation mode of the frame-by-frame driving described in part (a) of FIG. 11 ((0) frame-by-frame driving), the acquisition interval of the linear-sum signal data for the averaging process is one frame, and the polarity of all the linear-sum time-series signals acquired is the same. A frequency with a poor attenuation characteristic is (1/Flame)×N.

In an operation mode of the phase continuous driving described in part (b) of FIG. 11 ((1) phase continuous driving), the acquisition interval of the linear-sum signal data for the averaging process is one phase, and the polarity of all the linear-sum time-series signals acquired is the same. A frequency with a poor attenuation characteristic is (1/phase)×N.

In an operation mode of the identical-vector continuous driving described in part (c) of FIG. 11 ((2) vector continuous driving), the acquisition interval of the linear-sum signal data for the averaging process is two phases, and the polarity of all the linear-sum time-series signals acquired is the same. A frequency with a poor attenuation characteristic is (½phase)×N.

In an operation mode of the plurality-of-vector continuous driving described in part (d) of FIG. 11 ((3) M-vector continuous driving), the acquisition interval of the linear-sum signal data for the averaging process is 2 phases×M, and the polarity of all the linear-sum time-series signals acquired is the same. A frequency with a poor attenuation characteristic is (1/(2×M) phase)×N.

In an operation mode of the phase continuous inverted driving in which phase driving is continuously performed while inverting even-numbered driving described in part (a) of FIG. 12 and part (b) of FIG. 16 ((4) phase continuous driving inverted for even-numbered times), the acquisition interval of the linear-sum signal data for the averaging process is (1 phase−ΔT), and the polarity of the linear-sum time-series signals acquired inverts for even-numbered times. A frequency with a poor attenuation characteristic is (1/(1 phase−ΔT))×(N+0.5).

In an operation mode of the identical-vector continuous inverted driving in which vector driving is continuously performed while inverting the even-numbered driving described in part (b) of FIG. 12 and part (b) of FIG. 15 ((5) vector continuous driving inverted for even-numbered times), the acquisition interval of the linear-sum signal data for the averaging process is (2 phases−ΔT), and the polarity of the linear-sum time-series signals acquired inverts for even-numbered times. A frequency with a poor attenuation characteristic is (1/(2 phase−ΔT))×(N+0.5).

In an operation mode of the plurality-of-vector continuous inverted driving in which vector driving is continuously performed while inverting even-numbered driving described in part (c) of FIG. 12 and part (b) of FIG. 17 ((6) M-vector continuous driving inverted for even-numbered times), the acquisition interval of the linear-sum signal data for the averaging process is (2×M) phases, and the polarity of the linear-sum time-series signals acquired inverts for even-numbered times. A frequency with a poor attenuation characteristic is (1/(2×M) phase)×(N+0.5).

(Operation of Amount-of-Noise Estimation Circuit 9)

The amount-of-noise estimation circuit 9 makes a determination using a plurality of outputs of the linear element estimation unit (plurality of estimation results of values of the linear elements CX or inputs of the linear elements CX obtained by addition-subtraction-based signal processing). The switch circuit 6 switches between the sub-systems 5a and 5b on the basis of an estimation result obtained by the amount-of-noise estimation circuit 9. The plurality of estimated values are supposed to be the same value. When the plurality of estimated values are not the same value, the amount-of-noise estimation circuit 9 estimates that the influence of the amount of noise mixing into the estimated results has increased.

(Configuration of Sub-Systems)

The plurality of sub-systems included in the control circuit 14 can be configured into various types based on the above description in order to reduce external noise.

For example, a sub-system for which a unit in which a plurality of linear-sum signals based on the identical-phase driving of the identical-vector driving are added and average is set to a unit of a frame, a sub-system for which the addition-averaging unit is set to a unit of a phase, a sub-system for which the addition-averaging unit is set to a unit of a vector, and a sub-system for which the addition-averaging unit is set to a unit of a plurality of vectors may be provided, and any of these sub-systems may be selected so as to reduce external noise on the basis of the frequency characteristic between the normalized frequency and the rate of amplitude change.

In the case where this addition-averaging unit is a unit of a phase, a unit of a vector, and a unit of a plurality of vectors, a sub-system having a function for inverting the sign of the drive signal may be provided. In this case, sub-systems for which the driving inversion period is a unit of N phases (N is an integer) may be provided, and any of these sub-systems may be selected to reduce external noise based on the frequency characteristic.

Also, in the case where the drive-signal driving inversion function is provided, a sub-system that reduces the reset period of the reset signal that resets the amplification circuits may be provided.

### Second Embodiment

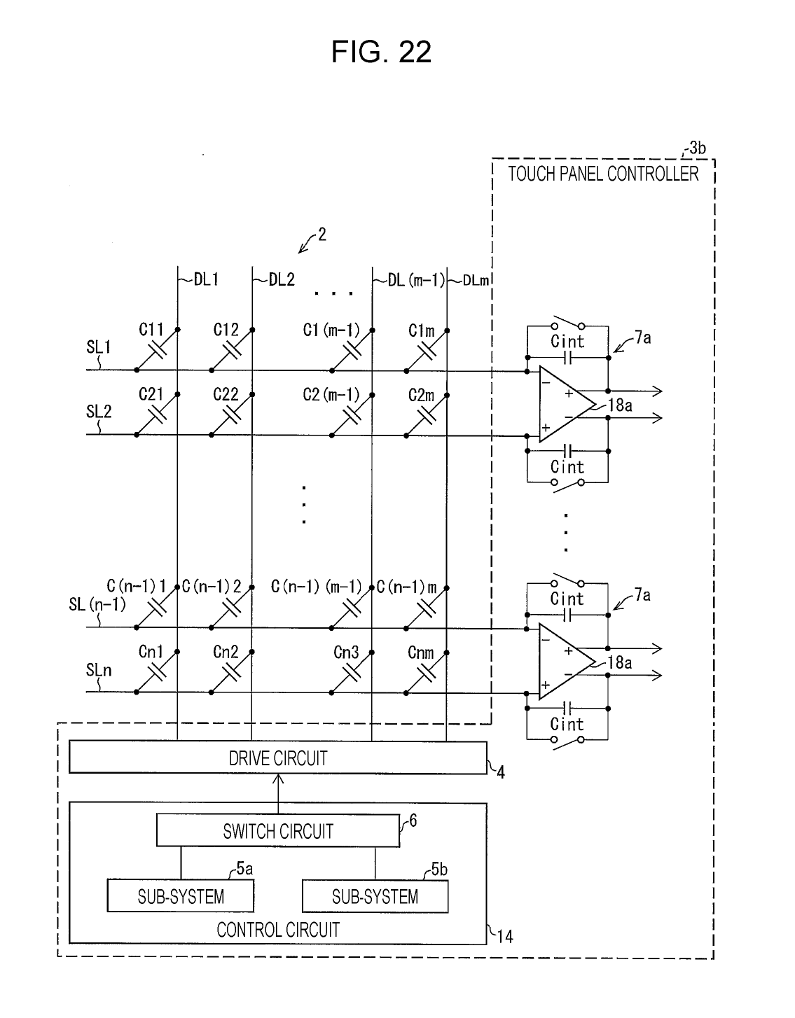

Another embodiment of the present invention will be described based on FIG. 22, which is as follows. Note that members having the same functions as those in the figures described in the above embodiment are assigned the same reference signs for convenience of explanation, and the description thereof is omitted.

FIG. 22 is a circuit diagram illustrating a configuration of a touch panel system according to a second embodiment. The touch panel system according to the second embodiment includes a touch panel controller 3b. The touch panel controller 3b includes amplification circuits 7a. The amplification circuits 7a each include a differential amplifier 18a. The differential amplifier 18a receives and amplifies linear-sum signals read along sense lines adjacent to each other.

If the amplification circuits each include a differential amplifier in this manner, noise robustness of the touch panel controller can be further enhanced.

### Third Embodiment

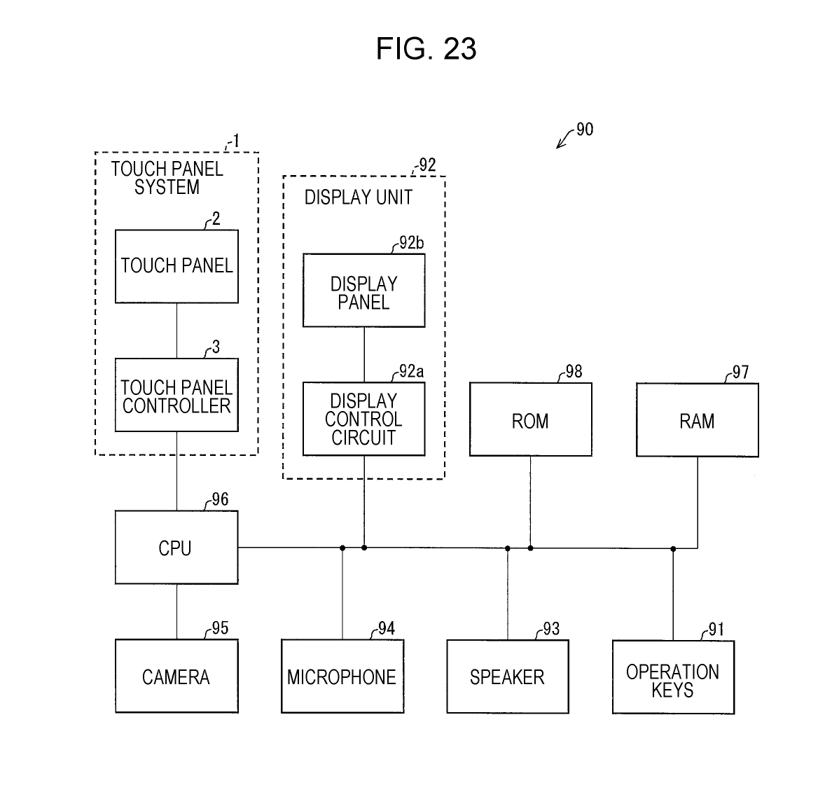

FIG. 23 is a block diagram illustrating a configuration of a mobile phone 90 (electronic device) according to a third embodiment. The mobile phone 90 includes a CPU 96, a RAM 97, a ROM 98, a camera 95, a microphone 94, a speaker 93, operation keys 91, a display unit 92 including a display panel 92b and a display control circuit 92a, and the touch panel system 1. The individual components are connected to each other via a data bus.

The CPU 96 controls an operation of the mobile phone 90. The CPU 96 executes a program stored in the ROM 98, for example. The operation keys 91 accept an instruction input by a user of the mobile phone 90. The RAM 97 volatilely stores data generated as a result of execution of the program by the CPU 96 or data input via the operation keys 91. The ROM 98 non-volatilely stores data.

The ROM 98 is a writable and erasable ROM, such as an EPROM (Erasable Programmable Read-Only Memory) or a flash memory. Although not illustrated in FIG. 23, the mobile phone 90 may include an interface (IF) allowing a connection to another electronic device by a cable.

The camera 95 captures an image of a subject in response to a user operation on one of the operation keys 91. Image data of a captured image of the subject is stored in the RAM 97 or an external memory (e.g., a memory card). The microphone 94 accepts input of user's voice. The mobile phone 90 digitizes the input voice (analog data). The mobile phone 90 then sends the digitized voice to a computation counterpart (e.g., another mobile phone). The speaker 93 outputs sound based on music data stored in the RAM 97, for example.

The touch panel system 1 includes the touch panel 2 and the touch panel controller 3. The CPU 96 controls an operation of the touch panel system 1. The CPU 96 executes a program stored in the ROM 98, for example. The RAM 97 volatilely stores data generated as a result of execution of the program by the CPU 96. The ROM 98 non-volatilely stores data.

The display panel 92b displays an image stored in the ROM 98 or the RAM 97 in accordance with the display control circuit 92a. The display panel 92b is disposed on the touch panel 2 or included in the touch panel 2.

### CONCLUSION

The signal processing system 10 according to a first aspect of the present invention is a signal processing system that estimates a value of the linear element CX or an input of the linear element CX by performing addition-subtraction-based signal processing on a plurality of time-series signals time-discretely sampled based on the linear element CX and includes the sub-systems 5a and 5b having different input/output transfer characteristics, and the switch circuit 6 that switches between the sub-systems 5a and 5b and connects one of the sub-systems 5a and 5b to the linear element CX, based on a frequency and an amount of noise mixing into the time-series signals and the input/output transfer characteristics so as to reduce noise mixing into an estimated result of the value or input of the linear element CX. The sub-system 5a performs frame-by-frame driving in which frame driving Flame0 to frame driving FlameM are performed, in each of which vector driving Vector0 to vector driving VectorN each including even-numbered phase driving Phase0 and odd-numbered phase driving Phase1 are performed in this order (where N and M are integers). The 2 sub-system 5b performs plurality-of-vector continuous driving in which vector driving Vector(k) to vector driving Vector(k+j) of each of the frame driving Flame0 to FlameM (where k and j are integers that satisfy 1≦k≦N and 1≦j≦N−1, respectively) are performed in this order.

According to the above configuration, the sampling frequency and the number of multiple sampling for the time-series signals differ between the plurality-of-vector continuous driving and the frame-by-frame driving. Thus, by selecting one of the plurality-of-vector continuous driving and the frame-by-frame driving on the basis of a frequency characteristic between an amount of amplitude change of the time-series signals and a normalization coefficient, which is a ratio between the frequency of the time-series signals and the sampling frequency, noise mixing into an estimated result of the value or input of the linear element is successfully reduced by performing addition-subtraction-based signal processing based on a frequency and an amount of noise mixing into the plurality of time-series signals time-discretely sampled based on the linear element and the input/output transfer characteristics.

The signal processing system according to a second aspect of the present invention, in the first aspect, further includes a sub-system having an input/output transfer characteristic different from those of the sub-systems 5a and 5b. The sub-system may perform either identical-vector continuous driving in which k-th vector driving (where 1≦k≦N+1) of each frame driving is continuously performed or phase continuous driving in which even-numbered phase driving included in each k-th vector driving (where 1≦k≦N+1) of each frame driving is continuously performed and then odd-numbered phase driving included in each k-th vector driving is continuously performed.

According to the above configuration, the sampling frequency and the number of multiple sampling for the time-series signals in the identical-vector continuous driving and the phase continuous driving differ from those of the plurality-of-vector continuous driving and the frame-by-frame driving. Thus, by selecting one of the identical-vector continuous driving, the phase continuous driving, the plurality-of-vector continuous driving, and the frame-by-frame driving on the basis of a frequency characteristic between an amount of amplitude change of the time-series signals and a normalization coefficient, which is a ratio between the frequency of the time-series signals and the sampling frequency, noise mixing into an estimated result of the value or input of the linear element is successfully reduce by performing addition-subtraction-based signal processing based on a frequency and an amount of noise mixing into the plurality of time-series signals time-discretely sampled based on the linear element and the input/output transfer characteristics.

The signal processing system according to a third aspect of the invention, in the first aspect, further includes a third sub-system having an input/output transfer characteristic different from those of the first sub-system and the second sub-system. The third sub-system may perform any of phase continuous inverted driving, in which even-numbered phase driving included in each k-th vector driving (where 1≦k≦N+1) of each frame driving is continuously performed such that a positive/negative sign of the plurality of time-series signals inverts with time for each even-numbered phase driving and then odd-numbered phase driving included in each k-th vector driving is continuously performed such that the positive/negative sign of the plurality of time-series signals inverts with time for each odd-numbered phase driving; identical-vector continuous inverted driving, in which the k-th vector driving (where 1≦k≦N+1) of each frame driving is continuously performed such that the positive/negative sign of the plurality of time-series signals inverts with time for each vector driving; and plurality-of-vector continuous inverted driving, in which the k-th vector driving to (k+j)-th vector driving of each frame driving are performed in this order such that the positive/negative sign of the plurality of time-series signals inverts with time for each set of the k-th vector driving to the (k+j)-th vector driving.

According to the above configuration, the sampling frequency and the number of multiple sampling for the time-series signals in the phase continuous inverted driving, the identical-vector continuous inverted driving, and the plurality-of-vector continuous inverted driving differ from those of the plurality-of-vector continuous driving and the frame-by-frame driving. Thus, by selecting one of the phase continuous inverted driving, the identical-vector continuous inverted driving, and the plurality-of-vector continuous inverted driving on the basis of a frequency characteristic between an amount of amplitude change of the time-series signals and a normalization coefficient, which is a ratio between the frequency of the time-series signals and the sampling frequency, noise mixing into an estimated result of the value or input of the linear element is successfully reduced by performing addition-subtraction-based signal processing based on a frequency and an amount of noise mixing into the plurality of time-series signals time-discretely sampled based on the linear element and the input/output transfer characteristics.

In the signal processing system according to a fourth aspect of the present invention, in the first aspect, the switch circuit 6 may determine and change the number of multiple sampling and the sampling frequency of the time-series signals obtained from the linear element CX.

According to the above configuration, it is possible to switch the sub-system to a sub-system capable of reducing noise on the basis of a frequency characteristic between an amount of amplitude change of the time-series signals and a normalization coefficient, which is a ratio between the frequency of the time-series signals and the sampling frequency.

The signal processing system according to a fifth aspect of the present invention, in the first aspect, the switch circuit 6 may select to cause the positive/negative sign of the plurality of time-series signals to invert with time or keep the positive/negative sign constant with time.

According to the above configuration, the sampling frequency and the number of multiple sampling for the time-series signals differ depending on the presence/absence of inversion of the positive/negative sign. Thus, noise is successfully reduced by selecting a driving method on the basis of a frequency characteristic between an amount of amplitude change of the time-series signals and a normalization coefficient, which is a ratio between the frequency of the time-series signals and the sampling frequency.

The signal processing system according to a sixth aspect of the present invention, in the first aspect, further includes the amount-of-noise estimation circuit 9 that estimates the amount of noise from the estimated value of the linear element CX or the estimated value of the input of the linear element CX obtained by addition-subtraction-based signal processing on the time-series signals, and the switch circuit 6 may switch between the sub-systems 5a and 5b on the basis of an estimation result obtained by the amount-of-noise estimation circuit 9 to select whether the positive/negative sign of the plurality of time-series signals inverts with time or is constant with time and to determine and change the number of multiple sampling and the sampling frequency of the time-series signals from the linear element CX.

According to the above configuration, noise is successfully reduced by making selection, determination, and change based on a frequency characteristic between an amount of amplitude change of the time-series signals and a normalization coefficient, which is a ratio between the frequency of the time-series signals and the sampling frequency.

The signal processing system according to a seventh aspect of the present invention, in the first aspect, may further include the analog-digital conversion circuit 13 that performs analog-digital conversion on a plurality of time-series signals based on the linear element CX and generates the plurality of time-series signals time-discretely sampled.

According to the above configuration, the value of the linear element CX or input of the linear element CX is successfully estimated by digital signal processing.

A touch panel system according to an eighth aspect of the present invention is the touch panel system 1a including the touch panel 2 including a plurality of capacitors disposed at respective intersection points of a plurality of drive lines and a plurality of sense lines, and the touch panel controller 3a that controls the touch panel 2. The touch panel controller 3a includes the drive circuit 4 that drives the capacitors along the drive lines, the amplification circuits 7 that read along the sense lines and amplify a plurality of linear-sum signals based on the capacitors driven by the drive circuit 4, the analog-digital conversion circuit 13 that performs analog-digital conversion on outputs of the amplification circuits 7, the decoding computation circuit 8 that estimates capacitances of electric charge accumulated in the capacitors on the basis of the analog-digital-converted outputs of the amplification circuits 7, the sub-systems 5a and 5b having different input/output transfer characteristics, and the switch circuit 6 that switches between the sub-systems 5a and 5b and connects one of the sub-systems 5a and 5b to the linear element CX. The sub-system 5a performs frame-by-frame driving in which frame driving Flame0 to frame driving FlameM are performed, in each of which vector driving Vector0 to vector driving VectorN each including even-numbered phase driving Phase0 and odd-numbered phase driving Phase1 are performed in this order (where N and M are integers). The second sub-system performs plurality-of-vector continuous driving in which vector driving Vector(k) to vector driving Vector(k+j) (where, k and j are integers that satisfy 1≦k≦N and 1≦j≦N−1, respectively) of each of the frame driving Flame0 to FlameM are performed in this order.

In the touch panel system according to a ninth aspect of the present invention, in the eighth aspect, the amplification circuit 7a may include the differential amplifier 18a that differentially amplifies linear-sum signals output along adjacent sense lines.

According to the above configuration, noise robustness of the touch panel controller is successfully enhanced further.

An electronic device according to a tenth aspect of the present invention includes the touch panel system according to the eighth or ninth aspect of the present invention and the display unit 92 compatible with the touch panel system.

The present invention is not limited to each of the above-described embodiments, and various alterations can occur within the scope recited in the claims. An embodiment obtained by appropriately combining the technical means disclosed in the different embodiments is also within the technical scope of the present invention. Further, a new technical feature can be formed by combining the technical means disclosed in the individual embodiments.

### INDUSTRIAL APPLICABILITY

The present invention can be utilized in a signal processing system that estimates a value of a linear element or an input of the linear element by performing addition-subtraction-based signal processing on a plurality of time-series signals time-discretely sampled based on the linear element, a touch panel system that includes a touch panel including a plurality of capacitors disposed at respective intersection points of a plurality of drive lines and a plurality of sense lines and a touch panel controller that controls the touch panel, and an electronic device.

### REFERENCE SIGNS LIST

1 touch panel system
2 touch panel
3 touch panel controller
4 drive circuit
5a, 5n sub-system (first sub-system, second sub-system)
6 switch circuit
8 decoding computation circuit
9 amount-of-noise estimation circuit
10 signal processing system
11 linear element estimation unit
12 switch circuit
13 AD conversion circuit
14 control circuit
18, 18a amplifier
CX linear element

1. A signal processing system that estimates a value of a linear element or an input of the linear element by performing addition-subtraction-based signal processing on a plurality of time-series signals time-discretely sampled based on the linear element, the signal processing system comprising:
a first sub-system and a second sub-system having different input/output transfer characteristics; and
a switch circuit that switches between the first sub-system and the second sub-system and connects one of the first sub-system and the second sub-system to the linear element, based on a frequency and an amount of noise mixing into the time-series signals and the input/output transfer characteristics so as to reduce noise mixing into an estimated result of the value or input of the linear element,
wherein the first sub-system performs frame-by-frame driving in which first frame driving to (M+1)-th frame driving are performed, in each of which first vector driving to (N+1)-th vector driving each including even-numbered phase driving and odd-numbered phase driving are performed in this order (where N and M are integers), and
wherein the second sub-system performs plurality-of-vector continuous driving in which k-th vector driving to (k+j)-th vector driving (where k and j are integers that satisfy 1≦k≦N and 1≦j≦N−1, respectively) of each frame driving are performed in this order.

2. The signal processing system according to claim 1, further comprising: a third sub-system having an input/output transfer characteristic different from those of the first sub-system and the second sub-system,
wherein the third sub-system performs either identical-vector continuous driving, in which k-th vector driving (where 1≦k≦N+1) of each frame driving is continuously performed, or phase continuous driving, in which even-numbered phase driving included in each k-th vector driving (where 1≦k≦N+1) of each frame driving is continuously performed and then odd-numbered phase driving included in each k-th vector driving is continuously performed.

3. The signal processing system according to claim 1, further comprising: a third sub-system having an input/output transfer characteristic different from those of the first sub-system and the second sub-system,
wherein the third sub-system performs any of phase continuous inverted driving, in which even-numbered phase driving included in each k-th vector driving (where 1≦k≦N+1) of each frame driving is continuously performed such that a positive/negative sign of the plurality of time-series signals inverts with time for each even-numbered phase driving and then odd-numbered phase driving included in each k-th vector driving is continuously performed such that the positive/negative sign of the plurality of time-series signals inverts with time for each odd-numbered phase driving; identical-vector continuous inverted driving, in which the k-th vector driving (where 1≦k≦N+1) of each frame driving is continuously performed such that the positive/negative sign of the plurality of time-series signals inverts with time for each vector driving; and plurality-of-vector continuous inverted driving, in which the k-th vector driving to (k+j)-th vector driving of each frame driving are performed in this order such that the positive/negative sign of the plurality of time-series signals inverts with time for each set of the k-th vector driving to the (k+j)-th vector driving.

4. A touch panel system comprising: a touch panel including a plurality of capacitors disposed at respective intersection points of a plurality of drive lines and a plurality of sense lines; and
a touch panel controller that controls the touch panel,
the touch panel controller including a drive circuit that drives the capacitors along the drive lines,
amplification circuits that read along the respective sense lines and amplify a plurality of linear-sum signals based on respective capacitors driven by the drive circuit,
an analog-digital conversion circuit that performs analog-digital conversion on outputs of the amplification circuits,
a decoding computation circuit that estimates capacitances of electric charge accumulated in the capacitors on the basis of the analog-digital-converted outputs of the amplification circuits,
a first sub-system and a second sub-system having different input/output transfer characteristics, and
a switch circuit that switches between the first sub-system and the second sub-system and connects one of the first sub-system and the second sub-system to the capacitors,
wherein the first sub-system performs frame-by-frame driving in which first frame driving to (M+1)-th frame driving are performed, in each of which first vector driving to (N+1)-th vector driving each including even-numbered phase driving and odd-numbered phase driving are performed in this order (where N and M are integers), and
wherein the second sub-system performs plurality-of-vector continuous driving in which k-th vector driving to (k+j)-th vector driving (where k and j are integers that satisfy 1≦k≦N and 1≦j≦N−1, respectively) of each frame driving are performed in this order.

5. An electronic device comprising: the touch panel system according to claim 4; and
a display unit compatible with the touch panel system.
